(19) United States
(12) Patent Application Publication
(10) Pub. No.: US 2004/0148341 A1
(43) Pub. Date: Jul. 29, 2004

(54) Web site having an individual event settings element

(75) Inventor: Pierre-Alain Cotte, Amberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB.DE AG, Karlsruhe (DE)

(21) Appl. No.: 10/354,671

(22) Filed: Jan. 29, 2003

(51) Int. Cl. G06F 15/16

(52) U.S. Cl. 709/203; 709/219

(57) ABSTRACT

A web site for providing communications includes an individual event settings element and a processing device. The individual event settings element is configured to define a rule for responding to an event. The processing device is configured to provide, upon an accessing of a web page of the web site, private communications between an end user unit and a specific entity associated with the web page.

### BACKGROUND

In general, the present invention relates to communications environments for an end user unit communicating via the communications environment and related systems, devices, units and methods for communications purposes. In particular, the present invention relates to a communications environment wherein communications from and to an end user unit are executed via a general-purpose communications interface, referred to herein as a telecommunications web site, in a private manner with respect to the communicating parties, the telecommunications web site including an individual event settings element configured to define a rule for responding to an event.

Traditionally, in order to accomplish personalized and private communications, postal service-based communications, e.g., by letters, personally addressed to a receiving party uniquely characterized by a name and address are used. A further example, of private communications personally directed to a party are telephone network-based communications, e.g., telephone calls, facsimiles and telexes, wherein a telephone number uniquely indicate the addressee.

In view of a demand for enhanced communications, computer network-based communications, e.g., via the Internet, have partially replaced the traditional communications. Although, computer network-based communications exhibit some benefits compared to postal service-based and telephone network-based communications, e.g., a higher transmission rates for text and graphic data, transmissions of different data formats via a common communications link and transmissions of high data amounts and loads, some of the advantages of “writing letters” and “calling a person by telephone” have been abandoned for the sake of participating in new technology communications.

In the following, an overview of different conventional communications environments is given respectively indicating advantages and disadvantages thereof:

Conventional telephone systems (Public Switched Telephone Network (PSTN), mobile telephone networks, satellite and radio-based environments) used for voice provide for point-to-point communications links allowing virtually true and simultaneous bi-directional communications and (nearly) delay-free data transmissions. Beside the actions of communicating parties to input telephone numbers, to pick up telephone handsets, to speak and to listen and the like. Data transmissions between respective end user units (telephones) are not possible.

Further, the addressing of a party is based on worldwide valid addresses, i.e., telephone numbers, which uniquely identify a party. Thus, upon dialing the right telephone number, a communications link will be established to a desired party and, as a result, communications will occur only between the calling and the called party, i.e., communications will be personalized and private. However, the established communication will not necessarily be secure.

End user units for telephone communications environments, in particular for mobile communications environments, are small, light weight and not restricted to a special location, such that communications are possible wherever intended.

Thus, telephone-based communications are an easy and fast way to communicate. On the other hand telephone-based communications have limited data transmission capabilities, e.g., limited transmissions bandwidths. Therefore, for example, transmissions of video and audio data are possible in restricted extent only and multi-media communications links are not possible at all.

A further limitation of telephone environments is their restricted capability of event-based control of communications. In telephone environments, for example, it is possible to forward an incoming call to another telephone device in general but not selectively for specific calling parties only.

Computer-based communications environments (e.g., local area networks and the Internet) employ a plurality of hardware devices (e.g., computer systems and network modems) and, in particular, a vast number of different software applications (e.g., network browsers, e-mail applications, data conversion software and encoding and decoding software). A certain level of knowledge, understanding and experience is required by users of such communications environments specifically with respect to the use of software applications. For example, computer-based communications environments are based on complex addressing methods, which require, compared to telephone-based communications, an increased amount of user interaction and knowledge.

Further, computer-based communications environments do not provide for true bi-directional communications, i.e., communications performed simultaneously and virtually in real time. Rather, such communications are subsequently performed unidirectional data transmissions like data file exchanges, web page accesses and e-mail-based communications.

Moreover, due to the methods employed with computer-based communications environments for actually transmitting data (e.g., asynchronous file transfer of data packets, least cost network routing strategies and utilization of different physical communications links for one communications connection), voice and video data transmissions are restricted. Further drawbacks of computer-based communications environments include security problems (e.g., data interception) and undesired data communications (e.g., “junk mail”).

In computer-based communications environments, communications that can be compared with telephone-based communications in respect to personalization and privacy are based on e-mail applications. On the other hand, e-mail communication is, from its nature, more akin to enhanced letter writing rather than bi-directional communication, such as directly talking via telephones.

Additionally, computer-based communications environments have restricted capabilities to control communications on the basis of events. Using e-mail applications, for example, it is only possible to forward received e-mail messages to another party (e.g., by means of another e-mail address) or to filter undesired e-mail messages such that they are not actually received by the party to which they are addressed (e.g., junk mail filter).

A further example of computer-based communications is web sites/web pages. Web sites generally provide for unidirectional communications, in particular transmissions of data and information to end user units and its users, respectively, accessing a web site. Moreover, private communications comparable to telephone communications are not possible since web sites are accessible by anybody or by a predefined group of users.

Both, telephone and computer-based communications environments are isolated from each other. Thus, separate addresses and addressing methods are employed for telephone and computer-based communications environments. As a result, communications can only be established within one environment and cannot be interconnected to another one.

### SUMMARY OF THE INVENTION

The present invention provides a web site for providing communications. The web site includes an individual event settings element and a processing device. The individual event settings element is configured to define a rule for responding to an event. The processing device is configured to provide, upon an accessing of a web page of the web site, private communications between an end user unit and a specific entity associated with the web page.

The rule may define a second event to be created when at least one criterion is satisfied. The criterion may include the event and the at least one other event related by logical operators. Moreover, the individual event settings element may be configured to define the rule for responding to the event in combination with at least one other event.

The present invention also provides a communications environment. The communications environment includes a first end user unit configured for performing network-based communications and a web site corresponding to a specific entity and including an individual event settings element. The individual event settings element is configured to define a rule for responding to an event. The web site is configured to provide, upon an accessing of the web site, private communications between the first end user unit and the specific entity.

The present invention also provides a method for providing communications. The method includes: providing a web site configured to provide private communications between a calling party and a specific entity associated with a web page of the web site; providing the web site with an individual event settings element; defining, using the individual event settings element, a rule for responding to an event; and responding to the event as a function of the rule.

Also provided by the present invention is a computer readable medium having stored thereon computer executable process steps operative to perform a method for providing communications. The method includes: providing a web site configured to provide private communications between a calling party and a specific entity associated with a web page of the web site; providing the web site with an individual event settings element; defining, using the individual event settings element, a rule for responding to an event; and responding to the event as a function of the rule.

The present invention may be employed to overcomes disadvantages existing in known communications environments while realizing advantages, such as privacy, ease of use, and/or data communications capabilities. The present invention may provide a communications environment capable of integrating various communications systems, such as computer-based networks, the Internet, PSTN networks, Universal Mobile Telecommunications System (UMTS) networks, mobile telephone networks, radio communications systems, satellite-based communications, etc.

### BRIEF DESCRIPTION OF THE DRAWINGS

In the following description, the present invention is elaborated upon based on exemplary embodiments, with reference to the drawings.

FIG. 1 shows a schematic diagram depicting private communications between a first end user unit and a specific entity via the telecommunications web site according to the present invention.

FIGS. 2a to 2d show schematic diagrams of four schemes according to which participants of the communication can be connected via a telecommunication web site.

FIG. 3 shows a schematic diagram of an embodiment of the communications environment according to the present invention.

FIG. 4 shows a schematic diagram of another embodiment of the communications environment according to the present invention.

FIGS. 5a and 5b show schematic diagrams illustrating two different ways in which participants of a communication can be connected via a telecommunication web site.

FIG. 6 shows a schematic diagram illustrating the way in which a participant A can communicate with a participant B using two different end user units that are controlled by the same telecommunications web site at the same time.

FIGS. 7a and 7b show schematic diagrams illustrating ways in which participants can communicate via one telecommunications web site and two telecommunications web sites, respectively.

FIG. 8 shows a schematic diagram of an embodiment of the communications environment according to the present invention featuring a telecommunications portal.

FIG. 9 shows a schematic diagram of another embodiment of the present invention in which two telecommunication web sites are provided on one telecommunications portal.

FIG. 10 shows a schematic diagram of an embodiment of the communications environment according to the present invention including two telecommunications web site telecommunications portals.

FIG. 11 shows a schematic diagram of an embodiment of the present invention with two telecommunication portals allowing communication between two participants.

FIG. 12 shows a schematic diagram of a telecommunications web site according to the present invention having an event identification element.

FIG. 13 shows a schematic diagram of a telecommunications web site according to the present invention having an event identification element and an event creation element.

FIG. 14 shows a telecommunications web site according to the present invention having an event identification element, an event creation element and a caller recognition element.

FIG. 15 shows a schematic diagram of a layout of a web page of a telecommunications web site according to the present invention.

FIGS. 16.01-16.11 show schematic diagrams of screen shots depicting a layout of a web page of a telecommunications web site according to the present invention.

FIG. 17 shows a schematic diagram of the architecture of an embodiment of the communication environment according to the present invention.

### DETAILED DESCRIPTION

In an embodiment the present invention provides a communications environment comprising a first end user unit being adapted to perform network-based communications, and a web site including at least one web page, wherein the web site is a telecommunications web site corresponding to a specific entity, and the telecommunications web site is adapted to provide, upon an access by the first end user unit, for private communications between the first end unit and the specific entity. Thus a new way of communications is disclosed where a specific entity or person can be contacted via a web site providing private communications between a caller and the host of this telecommunications web site. In Internet communication of the prior art, the parties do not communicate via a personalized web site. Even using a web site within a chat forum, this web site of the chat forum does not correspond to a specific person; rather there can be many different persons in the chat forum.

A communications environment may be a communications system comprising more than one component, i.e., more than one device and/or type of device, media and/or type of media, network and/or type of network. Thus, a communications environment or communications system might for instance comprise a telephone, a PSTN-network, a gateway to the Internet, etc.

The first end user unit, as any end user unit, is preferably a device that can be used for communications. The end user unit may be a telephone, a keyboard, a computer terminal, a mobile phone, a fax, a telex, a mail pigeon, an ordinary letter, a scanner, a PSTN device, a Third Generation (3G) wireless communications device, especially a UMTS device, etc. Moreover, the end user unit may be another telecommunications web site, a telecommunications portal comprising more than one telecommunications web sites or a device using a browser-based application.

The end user unit may include a user interface device and a network interface device. The user interface device provides for user input and/or output. The user interface device may be a telephone, a keyboard, a computer terminal, and/or a mobile communications device, for example. The network interface device may be a V.42, V.90, V.92 modem, a personal computer memory card international association (PCMCIA) modem, a digital subscriber line (DSL) modem, an integrated service digital network (ISDN) adapter, a cable modem, a wireless modem, an Ethernet card, or an integrated modem of a mobile phone, for example. The end user unit is not limited to a particular communications unit/device or any communications network. Rather, the end user unit may enable communications via any communications network such as regular telephone networks, mobile communications networks, computer networks, radio transmission networks, the Internet, etc. Further, the first end user unit is not restricted to single devices, but can also include two and more units, devices, and the like providing data/information sending and/or receiving capabilities for communications purposes, e.g., an ordinary letter and a scanner.

The end user unit is adapted to perform network-based communications. Thus, the end user unit is connectable to a network and able to communicate with a network. Thus, data information can be processed in a network. A network in this context may be a physical transport medium in which data and/or signal can be fed. For example, an ordinary letter itself is adapted to perform network-based communication when scanned or digitized and supplied into a transmission control protocol/Internet protocol (TCP/IP) network.

The terms “web site” and “web page” define sites and sub-sites associated thereto which can be uniquely addressed by means of a single address, like a telephone number or an IP address, a uniform resource locator (URL), etc. A web site may be used in a 3G-communication environment, especially an UMTS environment. A web site may be a site on the Internet with a specific URL, such as a site on the World Wide Web, which can be accessed by Internet visitors, and by the web site host. The web site host is the owner of the web site.

A web site can include one or more web pages. These web pages are part of the one web site. It should be noted that the terms “web site” and “web page” are not to be considered to limit the present invention to conventional Internet web sites and web pages. Thus, the web site and its web page(s), respectively, can be accessed by establishing a communications link from the first end user unit independently of the network(s) employed.

A telecommunications web site may be a web site adapted to provide, upon an access event, for private communications between two entities, as further discussed below. Preferably, the telecommunications web site corresponds to a first specific entity and is adapted to provide, upon an access by the first end user unit, for private communications between the first end user unit and the first specific entity. The terms “telecommunications web site”, “web site” and “web page” may be understood to encompass software and hardware components effecting these entities. Such components may include one or more processors, for example.

A telecommunications web site is assigned to or personalized for or corresponding to a specific person or entity. Such a first specific entity can be a person, a company or any other entity. The specific entity preferably acts as the host of the telecommunication web site. The specific entity may be a single entity, e.g., a specific user or owner (e.g., a single person, a company, a unit of a company, etc.) of the telecommunications web site, a specific address, a specific location, a specific end user unit and the like. Properties and functions of a telecommunications web site are described in commonly-assigned U.S. patent application Ser. No. 10/201446, entitled “Communications Environment,” filed Jul. 23, 2002, which is hereby incorporated by reference herein.

Preferably, the communication established between the first end user unit and the specific entity is a private communication. A private communication is a communication in which a third party cannot overhear the parties to the communication. The communication is not controlled by a third party or monitored by a person like a System Operator in a chat-forum. The communication takes place between the host of the telecommunications web site, i.e., the specific entity, and the visitor of the telecommunication web site, i.e., the person using the first end user unit. The private communication is a non-public communication.

The telecommunications web site of the present invention designates a site which is adapted and provided to be used for communication, preferably personal communication, private communication such as a telephone conversation, e-mail exchange, fax-communication, file-exchange, etc. The telecommunications web site may be adapted to be used for telecommunication, i.e., real time communication between two or more users using electronic media like a telephone or the Internet.

Thus, the communication may include only the user of the first end user unit and the person behind the specific entity. It is within the discretion of the person behind the specific entity to allow third parties to take part in this communication. The user of the first end user unit may be the “caller” and the person behind the specific entity may be the “called party” of such a private communication. It is also possible that the person behind the specific entity establishes the communication to the person behind the first end user unit. Such a communication will be established only between the first end user unit and the specific entity.

The telecommunications web site can, for instance, be accessed and controlled by the specific entity via a browser-based application. The browser may be a web browser, such as Netscape Navigator or Microsoft Internet Explorer, for example. The specific entity may then receive-all communication on this telecommunications web site. For example, in order to provide for private communications with a desired person, the respective telecommunications web site of this person is accessed by means of the first end user unit, e.g., under control of a controlling user or system. In response to the telecommunications web site access, the telecommunications web site enables direct and private communications with the specific entity, here the desired person. In other words, communications by means of the telecommunications web site are personalized with respect to the “called” specific entity.

Preferably, the communication takes place on this specific and personalized telecommunications web site, i.e., this specific URL identifying the specific entity, i.e., the called party as host of the telecommunications web site. The telecommunications web site might then be used interactively, i.e., the communication may take place between the caller and the called party as in a telephone conversation. Both, the caller and the called party then use the same address for the interaction, for example the same URL. It might even be the case, that both the calling party and the called party use telephones as end user units then the telecommunications web site works as a virtual operator connecting both the calling party and the called party.

As is discussed below, the telecommunications web site serves as a general-purpose communications interface for end user units and addressed entities that can include or can be an end user unit itself. As an illustration, the telecommunications web site can be considered as a communications “window”, similar to a window of an office counter, where communicating parties are “sitting” on opposite sides of the window and can communicate through speech holes in the window, via an intercom, by gestures, by facial expressions, showing papers with information written thereon, passing documents through a hatch and so on. Comparable thereto, the telecommunications web site according to the present invention allows communications in a plurality of modes and by a plurality of types/formats of data/information.

Using the telecommunications web site communication may be provided over combinations of different types of communication links or paths. These different links may be part of different networks, such as PSTN, IP-based networks or UMTS networks, for example. The different links may be accessed by using different end user units.

In an embodiment, no spam-mail can be sent to a telecommunications web site. Spam-mail is sent to e-mail addresses. The access of the telecommunications web site via spam-mail programs is not possible where the address of the telecommunications web site is not an e-mail address.

In an embodiment of the present invention the telecommunications web site is adapted to provide for bi-directional private communications between the first end user unit and the specific entity. Thus, the established communication is intercommunicative and advantageous for persons who wish to communicate real time, i.e., where action, reaction and interaction are perceived as being instantaneous by a human being.

According to an embodiment, the communications environment comprises a second end user unit being associated with the specific entity and being adapted to perform network-based communications, wherein the telecommunications web site is adapted to provide for the private communications as private communications between the first end user unit and the second end user unit. Thus, the specific entity may use any end user unit end user unit desired to communicate with the other party, i.e., with the person behind the first end user unit. Thus, the specific entity is not limited to a device used to access the telecommunications web site (for instance via a browser-based application) but may rather use any known communication device. The second end user unit is not limited to a particular communications unit/device or any communications network. Here, the telecommunications web site is adapted to provide for the private communications as private communications between the first end unit and the second end user unit. The utilization of the second end user unit depends on the actually properties of the specific entity. In the case the specific entity is adapted to provide for communications comparable to an end user unit, the private communications can occur without any further end user unit. On the other hand, employing the second end user unit makes it possible to perform the private communications between the first end user unit and any type of end user unit serving as or being comprised by the second end user unit. For example, if the specific entity is a single person, private communications can take place between any communications device of this person, e.g., a personal (portable) computer, a mobile telephone, a fax machine, a telephone, UMTS devices, memory devices, etc., and the first end user unit.

Communications via the telecommunications web site are not limited to a specific type of end user unit and specific entity. In particular, telecommunications web site-based communications can originate from and can be designated to any communications unit, such as telephones, personal computers, portable computer systems, fax devices and the like. Moreover, users of telecommunications web sites do not have to perform specific interactions in dependence of used end user units. Rather, the end user units are used in a common manner. For example, in the case of the first end user unit being a telephone, address information (like a telephone number) is inputted by the calling user and a communications link is established to the called destination (here the specific entity or an associated end user unit and a user thereof, respectively). Then, interacting with the respective end user units can perform communications. In particular, called and calling users can use their end user units independently of the type of end user unit of the counterpart end user unit. As result, for example, a calling user can utilize a telephone, while the called user communicates by means of a personal computer.

The present also provides a telecommunications web site, comprising at least one web page, wherein the web site is a telecommunications web site corresponding to a specific entity, and the telecommunications web site is adapted to provide, upon an access by a first end user unit, for private communications between the first end unit and the specific entity.

In an embodiment the present invention also provides a method including the steps of: providing a web site including at least one web page corresponding to a specific entity and being adapted to provide private communications, accessing the telecommunications web site by a first end user unit, and providing, in response to the accessing the telecommunications web site by the first end user unit, private communications between the first end user unit and the specific entity.

The private communications may be provided as bi-directional private communications between the first end user unit and the specific entity by the telecommunications web site.

Preferably, the communications link is a multi-protocol chain, i.e., a chain of multiple communications links of different types. The individual links may carry various types of communications media (voice, data, video, etc.). Thus, it is possible to combine several communications links into one communications link. For instance, a PSTN-end user unit I may be connected via the PSTN-network via a gateway to the Internet. Via the TCP/IP protocol it may reach a first telecommunications web site on a first telecommunications portal. Then, a link from first telecommunications portal to a second telecommunications portal is provided via an optical fiber followed by an Asynchronous Transfer Mode-Wireless Local Loop (ATM-WLL) connection. On second telecommunications portal, the connection is realized via the TCP/IP protocol and to a second UMTS-based end user unit via a second gateway on the second telecommunications portal. Thus, several types of links are used to establish one communications link between the two end user units. Preferably, the communication is established according to the most effective path. Most effective preferably means the path with the highest quality of service. It may also mean the path with the lowest cost or billing structure, or a combination of these criteria.

Preferably, the mutliprotocol chain not only provides for one path or channel but for several channels in parallel. Thus, a chain may include several parallel chains, or paths, connecting one end user unit to another end user unit or even several end user units. These parallel chains may be identical or different to each other. Thus, it is possible to connect a person using a telephone and a fax machine in parallel to another person using one telecommunications web site on a computer and a UMTS device. The basic arrangement has two parallel paths or channels. These paths may be identical or based on different types of communications links. Each path may include only one type of communications link.

In an embodiment, the present invention provides a communications environment, comprising: a first end user unit being adapted to perform network-based communications, and a web site including at least one web page, wherein the web site is a telecommunications web site corresponding to a specific entity, and the telecommunications web site is adapted to provide, upon an access by the first end user unit, for private communications between the first end user unit and the specific entity, including a connection means for establishing a communications link from the first end user unit to the specific entity of the telecommunications web site. With this combination of a telecommunications web site with a connection means, it is possible to connect different end user units from different technical environments to each other. One PSTN-end user unit may connect to an IP-end user unit by virtue of the connection means. This connection is provided and/or established by virtue of the telecommunications web site. Preferably, this connection is established via the telecommunications web site.

The connection means may be controlled by the telecommunications web site. By controlling the connection means by the telecommunications web site, the telecommunications web site can work as a “virtual operator”. The telecommunications web site can now connect two or more end user units by controlling the connection means that are used to establish this specific connection between these end user units. This connection is established and/or provided by the telecommunications web site, not necessarily via the telecommunications web site. Of course, one of the end user units can be the telecommunications web site of the specific entity or the computer controlling the telecommunications web site, respectively.

The connection means may be a converter, an adapter, an IP-switch, an ATM-switch, a mechanical or electromechanical switching board, a protocol translator, a gateway, especially a telephone network gateway, a UMTS/G3 network gateway, a computer network gateway, a television network gateway, a cable network gateway and/or an Internet gateway or a combination of these components. With these components, the telecommunications web site may establish a connection between the specific end user units building up chains of components to establish this connection. Preferably, these chains of components also comprise transport means like cable, wire, networks, radio communications, etc.

A first gateway may be provided for establishing a communications link from the first end user unit to the telecommunications web site in response to a request by the first end user unit to access the telecommunications web site. Thus, the use of any end user unit for communicating by means of the communication environment is enabled. Thus, the use any of a variety of types of end user units for communicating using the communication environment is enabled. As an example, the first gateway can provide for a link between a PSTN network and a computer network or the Internet. Thus, a telephone as a first end user unit can communicate with a personal computer connected to the Internet as a second end user unit.

A second gateway may be provided configured for establishing a communications link from the telecommunications web site to the specific entity in response to the private communications provided by the telecommunications web site. Thus, various additional end user units can be connected to each other via the telecommunication web site telecommunications web site.

As a result, in a comparable manner, a restriction to any special type of specific entity usable with the telecommunications web site can be resolved. As an example, the second gateway can provide for a link between the telecommunications web site to a PSTN network, a computer network or the Internet servicing the specific entity.

With respect to both the first and second gateways, a communications link is not limited to a single physical data transmission link or line, but can include different transmission paths, utilized in series and/or in parallel. Thus, communications links can comprise communications links within different networks. Further, communications links can be established to different communications sources and/or destinations at the same time, e.g., in the case the first end user unit and/or the specific entity include different devices or means for sending and receiving communications data/information.

To enhance the performance of the communications environment according to the present invention and to obtain, at least partially, independence from other communications environments, the communications environment can comprise a network including at least one of a telephone network, a computer network and/or the Internet for performing at least one of the network-based communications and the private communications.

In this sense an optimization can be achieved by at least one of the first gateway and second gateway being at least one of a telephone network gateway, a computer network gateway and an Internet gateway.

In an embodiment, the present invention provides a first telecommunications web site corresponding to a first specific entity, wherein the first telecommunications web site is adapted to provide, upon an access by a second telecommunications web site corresponding to a second specific entity, for private communications between the first specific entity and the second specific entity.

The first and/or the second telecommunications web sites may be adapted to provide, upon an access by the other telecommunication web site, for data exchange between the first and the second telecommunications web site.

In an embodiment, the present invention provides a method for providing communications, including the steps of: providing a first telecommunications web site including at least one first web page corresponding to a first specific entity and being adapted to provide private communications; providing a second telecommunications web site including at least one second web page corresponding to a second specific entity and being adapted to provide private communications; accessing the first telecommunications web site by the second telecommunications web site; and providing, in response to the accessing the first telecommunications web site by the second telecommunications web site, private communications between the first specific entity and the second specific entity.

The method may include the step of providing, in response to the accessing, for data exchange between the first and the second telecommunications web site.

With a combination of a telecommunications web site and a connection means, especially a gateway, it is for instance possible for the specific entity as host of the telecommunications web site to establish a communication between the Internet-based telecommunications web site and a PSTN-network. Thus, it is not only possible to establish a communication over two telephones via the Internet but via a PSTN-network. The specific entity as host of the telecommunications web site can, for example, choose a connection between a first telephone as a first end user unit and another telephone as a second end user unit. The access to establish this communications link will then be initiated from the telecommunications web site via a controlling device to a PSTN-network between these two telephones. As an example, both telephones begin to ring—the connection is established in the PSTN-network between these two telephones on access through the telecommunications web site—but not via the telecommunications web site.

In an embodiment, the present invention provides a multi-protocol communications environment, comprising: a telecommunications web site corresponding to a specific entity, a first connection means adapted to connect a first end user unit and a first end user unit of the specific entity, a second connection means adapted to connect a second end user unit and a second end user unit of the specific entity wherein both the first connection means and the second connection means are controlled by the telecommunications web site. With this arrangement, it is possible to have a multi-protocol connection between two or more parties over different types of communication links, herein referred to as multi-protocol connection. This arrangement may be adapted to use the best connection for each link or type of link. The “best connection” may be the connection with the best quality of service or the lowest costs or a combination thereof.

A multi-protocol connection may include different types of communications links, such as links of PSTN-networks, UMTS-networks, TCP/IP based networks, etc. For example, the connection of a telephone in a PSTN-network to a UMTS device in an UMTS-includes is a multi-protocol connection. Such a connection in parallel with a connection of a computer in a TCP/IP based network to another computer in a TCP/IP based network is also a multi-protocol connection as herein defined. Thus, the parallel use of different types of communications links is a multi-protocol connection. The individual links may carry various types of communications media (voice, data, video, etc.).

Preferably, the first connection means is an IP-switch and/or the second connection means is a PSTN-switch. Thus, it is possible to connect two parties each using a telephone in a PSTN-network and a computer with a camera to exchange real time video data at the same time. Since the telecommunications web site is in control of both connection means, it is possible to handle this multi-protocol connection by the simple control of the telecommunications web site, i.e., a simple mouse click in a browser based application. Establishing such a multi-protocol connection is achieved by choosing the party to be called in the telecommunications web site and choosing the kind of connection(s) to be established. All different multi-protocol connections are then established by the telecommunications web site that controls the respective connection means to establish such a connection. In addition, the telecommunications web site controls the multi-protocol connection by controlling the respective connection means. If the connection is to be terminated, the telecommunications web site manages the shut down of all types of connection involved.

Preferably, the first end user unit and/or the first end user unit of the specific entity comprises at least one video device, especially a video camera and/or a video monitor. Especially wherein the second end user unit and/or the second end user unit of the specific entity comprises at least one PSTN device, especially a stationary telephone and/or a mobile telephone. With such an arrangement, it is possible to establish a videoconference. Preferably, such a videoconference is a combination of a PSTN-connection for the voice and a TCP/IP connection for the pictures to be transmitted. With such an arrangement, the voice will be transmitted with no delay and the pictures may have a certain delay in the transmission that on the other hand is acceptable for communication.

In an embodiment, the present invention provides a telecommunications web site corresponding to a specific entity comprising a first connection means adapted to connect a first end user unit and a first end user unit of the specific entity, a second connection means adapted to connect a second end user unit and a second end user unit of the specific entity wherein both the first connection means and the second connection means are controlled by the telecommunications web site. With such a telecommunications web site, a multi-protocol connection can be established and provided.

In an embodiment, the present invention provides a method of connecting two parties in a multi-protocol communications environment comprising the steps of: connecting to a telecommunications web site, choosing the kind of multi-protocol connection to be established, establishing each part of the chosen multi-protocol connection via a connection means controlled by the telecommunications web site. With this method, a multi-protocol connection or link can be established that allows for using different end user units in parallel in one connection to another party.

In an embodiment, the present invention provides a communications environment, comprising a first web site including at least one web page, wherein the first web site is a first telecommunications web site corresponding to a first specific entity, and a second web site including at least one web page, wherein the second web site is a second telecommunications web site corresponding to a second specific entity, and the first and/or the second telecommunications web sites are/is adapted to provide, upon an access by the other telecommunication web site, for private communications between the first specific entity and the second specific entity. With two telecommunications web sites, both, calling entity and called entity can benefit from the communication options and opportunities of a telecommunications web site.

In an embodiment, the first and/or the second telecommunications web site are/is adapted to provide, upon an access by the other telecommunication web site, for data exchange between the first and the second telecommunications web site. Thus, it is possible to exchange data between both telecommunications web sites without the specific entities having to actively communicate about the content of this data. The data exchange can take place simultaneously or even before the private communication between the specific entities is established.

Preferably, the data exchange comprises data including at least one of:

personal data of the specific entity;

communication preferences of the specific entity;

background information of the specific entity; and

a combination of any of the aforementioned data.

Thus, it is possible that specific data is exchanged that may have changed and needs to be updated. This can take place without the first specific entity having to actively inform the second specific entity about this new information and vice versa. Preferably, both telecommunications web sites exchange data. It is also possible that only one of the communicating telecommunications web sites provides data and the other telecommunications web site is adapted to download this data.

Such data to be exchanged may be personal data of the specific entity such as contact information (telephone number, fax number, e-mail, address, etc.), data of a more personal kind like birthday, matrimonial status (married, bachelor, etc.), nationality, home address, photos, movies, videos, articles, text, religious confession, professional information, etc.

Further, communication preferences of the specific entity may be exchanged. Such preferences may include the way how the person wants to be contacted (via telephone, via video-conference, via e-mail, etc.) or the time when this person wants to be contacted or the time zone in which the specific entity lives or works (western time, European time, etc.), meta information on communication, languages, data exchange formats, passwords, cookies, requirement of ssl-connection, virus scanner information, etc.

Further, background information of the specific entities may be exchanged like hobbies, personal interests, a resume of the specific entity, a homepage, etc.

The kind of data to be exchanged may be predefined by the specific entity. Thus, the specific entity defines not only the content of the data to be exchanged but also define what kind of data is to be exchanged. With that feature, the telecommunications web site can be prepared to share exactly the information and exchange that kind of data the specific entity predefined to share.

The data may be exchanged automatically. Thus, (new) data can be provided to the calling party, e.g., first specific entity, from the called party second specific entity without having to communicate actively about the new data. In a further embodiment, the data is exchanged on request of one party, e.g., the calling party, can select a button provided on the second telecommunications web site in order to download the data from the second specific entity.

In embodiment of the communication environment there are provided more than two telecommunications web sites. Thus, it is possible to communicate with more than one specific entity via the personal telecommunications web site of different entities. With such a standardized group of specific entities all using a personalized telecommunications web site, it is extremely easy to communicate and share information or exchange data to be distributed for the first time or updated. It is possible to inform people of a new address after having moved without the need to call and inform each person. The specific entity with the new address will inform any other specific entity with a telecommunications web site automatically the next time when communicating via the data exchange between the first and second telecommunications web site without “mentioning” the new address actively.

In an embodiment of the communication environment, all telecommunications web sites answer to the same basic protocol of data exchange. Thus, it is possible to exchange a minimum piece of information on each specific entity of a telecommunications web site via the data exchange between the telecommunications web sites. With such a standardized basic information protocol it is possible to exchange necessary data between all specific entities using a telecommunications web site. Such data preferably includes available communication channels, a security password, recognition data (cookies), virus scanner updates, and software updates.

In an embodiment, the present invention provides a first telecommunications web site corresponding to a first specific entity, wherein the first telecommunications web site is adapted to provide, upon an access by a second telecommunications web site corresponding to a second specific entity, for private communications between the first specific entity and the second specific entity. With such a telecommunications web site, full advantage can be taken of the communication via a telecommunications web site.

Preferably, the first and/or the second telecommunications web sites are/is adapted to provide, upon an access by the other telecommunication web site, for data exchange between the first and the second telecommunications web site.

As a result, it is advantageous to use two telecommunications web sites communicating with each other. Thus, through automation, an enhanced, faster, more secure and more pleasant way of communication is possible.

In an embodiment, the present invention provides a communications environment wherein at least one telecommunications web site is provided on a portal. Such a portal may be herein referred to as a telecommunications portal. For providing the telecommunications web site, it is preferred to use a telecommunications portal or a cluster of sub-telecommunications portals serving as a telecommunications portal. Each member of the telecommunications portal may use the infrastructure of the telecommunications portal. This enhances the nature of the telecommunications web site to serve as a general-purpose communications interface or communications “window”.

A telecommunications portal preferably has several resources that are accessible by all members of this telecommunications portal. Thus, all members can share these resources. The members of a telecommunications portal do not have to have their own resources but can benefit from the resources provided by the telecommunications portal. Such resources can be services or content data. Preferably, the services comprise navigation help such as search tools or directories, communication tools such as chat forum or e-mail or mobile phone services or a calendar tool or newsgroup servers/directories or encrypting services like certifications for secure communications or wake-up services. Further, the telecommunications portal might comprise entertainment services such as games in the field of the stock exchange market, services of a betting office, comics, greeting cards or radio stations to listen to. Further, the telecommunications portal might provide services on traffic information, download areas for software, providing webspace, services on registering domains, etc. Preferably, the telecommunications portal provides content data such as for instance news on financial issues, sport events, political news, television program, weather information or horoscopes. Further it might provide information systems for route planning, consumer services like ordering newsletters, online-shopping, modules for comparing services such as telephone fees, car rental fees or insurances. Further, the telecommunications portal might provide certain services with respect to the communication of the telecommunication web sites, e.g., a server shared by all telecommunications web sites that provides the history information of the connections of the telecommunications web site.

Preferably, the telecommunications portal comprises a connection means, or device, accessible by the at least one telecommunications web site. Such connection means are also resources of the telecommunications portal that can be used by the web sites of the telecommunications portal. These connection means may be means with which the telecommunications portal can connect to another network as described above. The connection means may include converters, adapters, IP-switches, ATM-switches, protocol translators, gateways, especially UMTS network gateways, or a combination thereof. With such resources, the telecommunications portal is a more advanced communication platform since on the telecommunications portal resources are provided which the single user of a telecommunication web site may not be able afford to acquire.

To enhance the nature of the telecommunications web site to serve as a general communication interface, a telecommunications portal having a plurality of telecommunications web sites may be used. Here, the telecommunications portal represents an accumulation of telecommunications web sites on the specific telecommunications portal. The telecommunication portal preferably has an integrated consistent addressing scheme, comprising each unique telecommunications web site residing on this telecommunications portal and thus enabling the definite assignment of different telecommunications web sites of a specific telecommunication portal by the structure of the telecommunications web site address. Preferably, such an integrated consistent addressing scheme is based on the same top and/or second level domain. Thus, a user of a telecommunications portal WEB.DE having the name “NAME1” may have an address according to an addressing scheme “NAME1.WEB.DE”, while another user having the name “NAME2” may have the address “NAME2.WEB.DE”. The name may be an alphanumerical figure, preferably a telephone number. Especially preferred is a telephone number with an alphanumerical prefix, designating the country of the user and/or the telecommunications portal. In another embodiment, such an addressing scheme is the use of a common feature in all the addresses of the users of one telecommunications portal. Such a common feature may be a prefix, a suffix, a certain format of a telephone number used as an address, etc. Thus, it can be recognized from the address, whether a user belongs to a certain telecommunications portal or not.

The telecommunications web sites residing on one telecommunications portal may be connected to each other. In contrast to telecommunication web sites not belonging to a specific telecommunications portal and thus communicating with each other by means of public accessible communication networks like the Internet, PSTN-networks, etc., the telecommunications portal i.e., the telecommunications web sites on a telecommunications portal, provides a particular, “physical” connection, e.g., a fiber optics or copper cable interconnection, that allows a stable, high speed and high-performing data transmission capability between different telecommunications web sites belonging to the same telecommunications portal and thus enhancing the communication possibilities. The telecommunications web sites provided, or residing, on a telecommunications portal may share or partially share hardware and/or software components. Preferably, the telecommunications web sites of one telecommunications portal are located on a same server or server set and use the same database.

In an embodiment, the present invention provides a telecommunications portal comprising at least two telecommunications web sites, wherein the telecommunications web sites on the telecommunications portal have an integrated consistent addressing scheme.

In an embodiment, the present invention provides a method for providing communications, including the steps of:

providing a first telecommunications web site including at least one first web page corresponding to a first specific entity and being adapted to provide private communications;

providing a second telecommunications web site including at least one second web page corresponding to a second specific entity and being adapted to provide private communications;

accessing the first telecommunications web site by the second telecommunications web site; and

providing, in response to the accessing the telecommunications web site by the second telecommunications web site, private communications between the first specific entity and the second specific entity;

wherein both telecommunications web sites reside on one telecommunications portal.

In an embodiment, the present invention provides a communications environment, comprising: a first web site including at least one web page, wherein the first web site is a first telecommunications web site corresponding to a first specific entity, and a second web site including at least one web page, wherein the second web site is a second telecommunications web site corresponding to a second specific entity, and the first and/or the second telecommunications web sites are/is adapted to provide, upon an access by the other telecommunications web site, for private communications between the first specific entity and the second specific entity wherein both the first and the second telecommunications web site are provided on a telecommunications portal. With two telecommunications web sites provided on a telecommunications portal, enhanced communication methods can be used. Thus, communication between two telecommunications web sites on a telecommunications portal is accomplished faster and more securely.

In an embodiment, the first and/or the second telecommunications web sites are/is adapted to provide, upon an access by the other telecommunications web site, for data exchange between the first and the second telecommunications web site. With such a data exchange, the communication between both telecommunications web sites can be improved. This data exchange can be accomplished faster since both telecommunications web sites are on the same telecommunications portal.

The data exchange between the two telecommunications web sites may be accomplished as in the case of two telecommunications web sites not belonging to the same telecommunications portal—but much faster and according to certain protocols that are valid on the telecommunications portal. Another advantage of telecommunications portals is the uniformed/standardized type of information and data which can be provided through a telecommunications web site and the way the information is processed, e.g., personal information of the specific entity corresponding to the telecommunications web site or presence information.

Moreover the telecommunications web site provides for a certain degree of trust applying to the data that is provided by a telecommunications web site on the one hand and the specific entity corresponding to a specific telecommunications web site on the other hand. This again enhances the communication possibilities and in particular the speed of data transmission between telecommunications web sites of the same telecommunications portal by the automation of certain authorization processes.

Thus, the arrangement of telecommunications web sites on a telecommunications portal enables an enhanced communication between specific entities corresponding to specific telecommunications web sites belonging to the same telecommunications portal by allowing for instance first specific entity to access second specific entity using, e.g., a stationary telephone first end user unit and nevertheless allowing the called second specific entity to find out automatically, that first specific entity is on his part assigned to a telecommunications web site of the same telecommunications portal. Thus, it is possible to establish a communication link not only to first end user unit but also to a multitude of single devices or means. Moreover, the telecommunications web site of second specific entity is able to establish automatically such enhanced communication to different end user units without requiring further action of one of the communicating entities since this information is present on the same telecommunications portal. Thus, first telecommunications web site knows automatically all possible end user units assigned to second entity and may use these for providing/establishing a communication between first specific entity and second specific entity.

Furthermore it is possible to access a certain telecommunications portal in order to retrieve data about the different telecommunications web sites residing on that telecommunications portal in total, for instance about the structure of specific entities (natural persons or companies, etc.) corresponding to the telecommunications web sites on this telecommunications portal.

In contrast to the communication scenarios provided by two communicating telecommunications web sites independently organized (i.e., without residing on or belonging to a specific telecommunications portal), through automation an enhanced, faster, more secure and more pleasant way of communication is possible.

Since the telecommunications web site are residing on or provided by a telecommunications portal, communication will be arranged “between” the communicating parties, here the first specific entity of a first telecommunications web site and the second specific entity of the second telecommunications web site, in a physical sense. Since both telecommunications web sites are physically provided on the same telecommunications portal, communication and especially data exchange can be accomplished much faster. In addition, the communication protocol may be standardized within one specific telecommunications portal. Thus, the connected telecommunications web sites can communicate directly since both telecommunications web sites “know” what data is to be exchanged within this specific telecommunications portal without having to crosscheck. This provides a faster and more secure connection between both telecommunications web sites of a specific telecommunications portal.

Preferably, the telecommunications portal is also adapted to establish communications links for performing the private communications. For example the telecommunications portal can, upon an access by the first telecommunications web site to the second telecommunications web site, establish a communications link there from to the first telecommunications web site. This communications link may be different compared to the communications link used for the access. As an option or in addition thereto, the telecommunications portal may establish a communications link from the telecommunications web site to the specific entity or to an associated end user unit.

In an embodiment, the present invention provides a communications environment wherein at least two telecommunications portals, each comprising at least one telecommunications web site, are provided. With two telecommunications portals, communication can be established between a first telecommunications web site residing on the first telecommunications portal and a second telecommunications web site residing on the second telecommunications portal. With the use of two telecommunications portals, the telecommunications web sites residing on different telecommunication portals may benefit from the infrastructure of both the telecommunications portals when connecting.

In an embodiment, the telecommunications portals are adapted to establish at least one connection, or communications link, for performing communications, especially private communications. Thus, the communication may be established between an end user unit 1 of a first telecommunications web site 1 on the first telecommunications portal that is supplied by a first gateway or connection means not available on the second telecommunications portal. Nevertheless, a communications link can be established since both the first telecommunications portal and the second telecommunications portal are connectable to each other. The communications link may be a multi-protocol chain, and thus have different types of communications links.

Preferably, the two telecommunications portals communicate according to a common protocol. With the use of a common protocol, the communications link can be established not only in a basic way but also in a more enhanced way. This allows for more speed and security in the communication between both first telecommunications portal and second telecommunications portal. Such a protocol may define specific ways of exchanging data and even specify certain information on the telecommunications web sites of the different telecommunications portals to be shared between both the first and second telecommunications portals.

Preferably, the communications link is a synchronous communication link. With such a synchronous communications link such as an ATM-link, the communication between the telecommunications portals can be realized in a real-time mode. This means that the communication is not adversely affected by delays in the transmission of the data. Preferably, the data packages are sent and received without delay that would cause an irritation with a human being, i.e., not causing a delay of more than 500 ms, preferably not more than 250 ms. A link with such little delay is accepted as “synchronous”. Preferably, the communication is not randomly packet orientated like in a TCP/IP connection. With TCP/IP, the data package is routed from the sender to the receiver according to a routing strategy. As a result, a package sent at a time t1 may be received by the receiver after having received a second package sent after the first package at time t2. The receiver then brings all packages back into order. Thus, the packages are received “asynchronous” rather than package after package, i.e., “synchronous”. If the packages are sent and received fast enough and brought back into order without causing a delay of more than 500 ms, such a link was still a synchronous link.

Possible ATM-links may be realized using ATM passive optical networks (APON), direct optical fiber connections or copper wires with for instance Asymmetric Digital Subscriber Line/High bit-rate Digital Subscriber Line technology, ATM-radio links (ATM-Wireless Local Loop, ATM-WLL), etc. Preferably, the connection link is established via a dedicated line.

In an embodiment the present invention provides a first telecommunication portal comprising at least a first telecommunications web sites, wherein the first telecommunications portal is adapted to provide for establishing at least one communications link to a second telecommunications portal.

In an embodiment of the present invention, the communications link is established according to a protocol predefined by the first telecommunications portal. Preferably, the first telecommunications portal provides for more than one protocol. Such a protocol may define the way in which communication is established between the two telecommunications portals. A telecommunications portal can have more than one protocol, preferably one protocol is chosen for establishing communication between two telecommunications portals. With such protocols, the communication between two telecommunications web sites belonging to different telecommunications portals can be enhanced. Such a protocol may define the way of automatic data exchange between the telecommunications portals. Such data may comprise the infrastructure of the telecommunications portal, e.g., the kind and number of resources of the telecommunications portal, information on which resources may be used by “visitors”, conditions that have to be satisfied to allow the usage of these resources, security information, information on the capacity of the telecommunications portal and/or the resources, number of telecommunications web sites in the telecommunications portal, languages spoken, lists of protocols, information on the time zone in which the telecommunications portal is operated, etc.

Preferably, the protocol provides a definition of the kind of data to be exchanged between a first telecommunications web site of the first telecommunications portal and a second telecommunication web site of the second telecommunications portal.

The communication link may be established between the first telecommunications web site of the first telecommunications portal and a second telecommunications web sites of the second telecommunications portal.

In an embodiment the present invention provides a method for providing communications, including the steps of:

providing a first telecommunications portal including a first telecommunications web site including at least one first web page corresponding to a first specific entity and being adapted to provide private communications;

providing a second telecommunications portal including a second telecommunications web site including at least one second web page corresponding to a second specific entity and being adapted to provide private communications;

accessing the first telecommunications web site by the second telecommunications web site; and

providing, in response to the accessing the first telecommunications web site by the second telecommunications web site, private communications between the first specific entity and the second specific entity via a communications link between the first telecommunications portal and the second telecommunications portal.

Preferably, the communications link is a physical link and/or a dedicated ATM link and/or a virtual private network.

The method may include the step of selecting a joint protocol for the communications link between the first telecommunications portal and the second telecommunications portal.

The interrelation of two telecommunication portals is preferably defined by their connection. Corresponding to the above-described connection between different telecommunications web sites residing on the same Telecommunication Portal again it is preferred to build up either a “physical” link between two telecommunications portals or a dedicated ATM link or a virtual private network. Other possible connections and links between two telecommunications portals are described above.

This in turn enhances the data transmission capability between first telecommunications web site belonging to the first telecommunications portal and telecommunications web site belonging to the second telecommunications portal in the same way it is enhanced within the same telecommunications portal.

In an embodiment of the present invention, the identical protocol of two web sites on the same telecommunications portal is applied for the communication between two telecommunications portals. Thus, the above mentioned uniformed/standardized type of information and data which can be provided through a telecommunications web site is processed between two telecommunications portals.

In another embodiment of the present invention, the protocol used between two telecommunications portals differs from the one used for two telecommunications web sites residing on the same telecommunications portal. For instance, a telecommunications portal dedicated to a certain company retrieves different data of the specific entities corresponding to the single telecommunications web sites residing on this telecommunications portal (e.g., rank, department, scope of duties) than a telecommunications portal dedicated to a commercial telecommunications web site-provider would.

Preferably, these standards differ from one telecommunications portal to another, which leads to a further characterization of the correlation of two different telecommunications portals: different telecommunications portals can agree on terms of enabling the conversion of certain data and information on basis of, e.g., a certain joint protocol. The areas of such conversion could be more or less restrictive, depending on the degree of trust between these telecommunications portals.

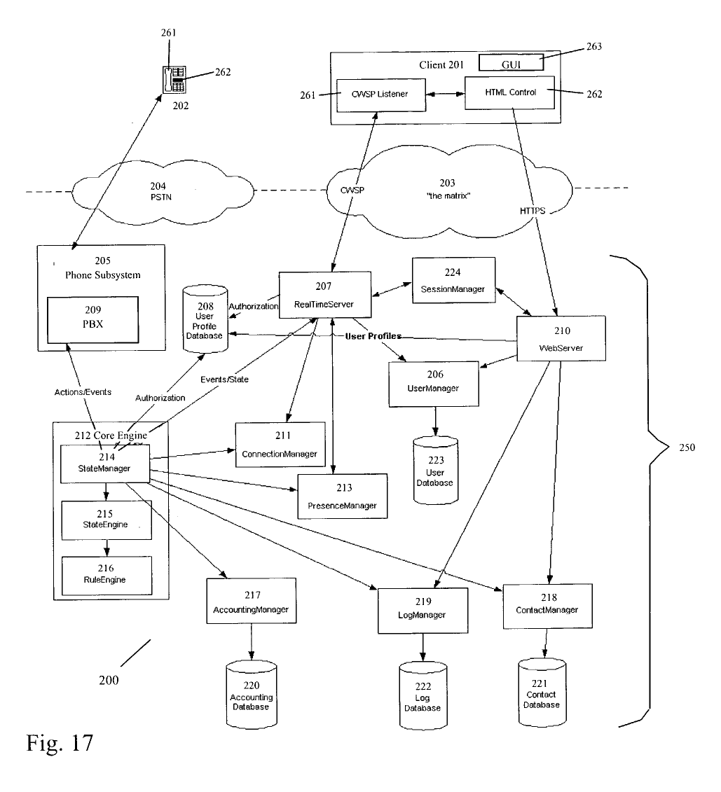

The protocols used between two telecommunications web sites may be any of a variety of communications protocols, for example the novel client-server signaling protocol described in European Patent Application No. 02 020 448.3, attorney docket number 31536.WEB.P100EP, entitled “Signaling Protocol,” and described below in the discussion of client 201 with reference to FIG. 17. European Patent Application No. 02 020 448.3 was filed by the assignee of the current application and is hereby incorporated by reference herein. Alternatively, another communications protocol may be used, such as Internet Inter-ORB Protocol (IIOP), HTTP, HTTPS, Simple Object Access Protocol (SOAP), FTP, SMTP, and, on lower levels, IMCP, UDP, TCP or any other protocol which supports the exchange of information and data.

An advantage of a communication of two telecommunications web sites belonging to different telecommunications portals is the range of possibilities for building up a communication link between them. In the case of no existing “physical” or virtual private link between the two telecommunications portals a communication of the two telecommunications web sites is possible via public, accessible communication networks such as the Internet or the PSTN-networks. Moreover, although the data transmission capabilities in this case may be well below those provided by a private link they are still clearly higher than even the capabilities of two telecommunications portal-independent telecommunications web sites because of the above described opportunities of joint protocol-based automatic data exchange.

In an embodiment the present invention provides a communications environment, comprising a telecommunications web site wherein the telecommunications web site has an event identification element. Also, the present invention provides a telecommunications web site having an event identification element. This telecommunications web site is preferably associated with a telecommunications portal as described above.

In general, an event may be a situation or occurrence which may change the state of the telecommunications web site.

The event identification element may identify incoming and/or internal events. An incoming event is an event that is directed to the telecommunications web site from outside. Preferably, these incoming events are events initiated by a telecommunication network or by an Internet-based network or by an UMTS network. These incoming events may be telephone calls by other parties, signals of incoming faxes, short message service (SMS) messages, e-mail, etc. Further, these incoming events may be signals from UMTS/3G devices, diverse Internet devices, signals from a news ticker and from newsgroups, etc. In a preferred embodiment of the present invention, these incoming events are events originated by a portal, especially a telecommunications portal. These events may also include calls and signals from this portal. Such signals preferably comprise signals referring to data describing news, e.g., news of the stock market provided by the portal, weather information, etc.

Internal events are events originated by the telecommunications web site or by data administered by the telecommunications web site. Such internal events may be predefined by the user of the telecommunications web site, for instance dates and actions to be taken dependent on date and time, certain other criteria like personal data for instance on birthdays, etc. An internal event may be originated by a database integrated or associated to the telecommunications web site that alerts the host or the user of the telecommunications web site that there was a meeting scheduled in the calendar of the telecommunications web site in an hour. Thus, the internal event may be a signal from this database to the event identification element that in an hour this meeting is scheduled to take place. Other internal events may be parameters or data within the system of the telecommunications web site such as for instance the information that there is no more storage to store data, conditions set by the user are fulfilled, virus scan software found a virus within the data of the telecommunications web site, spam was detected, data is to be transmitted to a group of users or to be transmitted with delay, a button was pushed on the web page of the telecommunications web site, a profile is to be loaded by the telecommunications web site, for instance a job profile from 8:00 a.m. to 8:00 p.m. and the private profile from 8:00 p.m. to 8:00 a.m., etc.

The event identification element may include a first set of hardware and software consisting of one or more telephone switches that are adapted to send events to core engines responsible for the identifications of events. A second set of hardware and software consists of one or more real-time servers and web servers communicating with clients via special protocols and https. The real-time servers are responsible for sending user events, such as, for example mouse clicks, timer events, etc., to one or more core engines that are in turn responsible for the identification of events.

Thus, with the event identification element the telecommunications web site may be capable of receiving and analyzing these incoming events. The incoming events may be stored and processed by the telecommunications web site in further steps.

In an embodiment of the present invention, events which the event identification element may identify include one or more of the following: an event of the group of telecommunications events, telephone calls, signals from faxes, SMS (short message system), wireless application protocol (WAP), page call, http call, i-mode call, web-site visit, multi media messaging service (MMS), e-mail, diverse telecom devices, especially telephones or faxes, dual tone multi frequency (DTFM) signals, network events, UMTS/3G devices, mouse click, status of a device, especially off-hook status of a telephone, scan status of a scanner, messages from newsgroups, presence of a person, especially the user or caller alerts, scheduled events, voice-over-IP calls, portal events, portal calls, calls from another telecommunications web site, radio network events, television signals, content modifications, keywords, status of an electrical device, video signals, biometrical data signals, status of a switch, login events or a combination of these events.

These events may include information on the presence of a person, especially the user or caller and/or the position where this person is located. The event may be the information, whether a person is sitting in front of its monitor or computer. This can be accomplished by sensors, preferably integrated into the monitor or the frame or housing of the monitor, which enables detecting the presence of the user. Further, these sensors may be sensors of a surveillance system, especially a common surveillance system for burglar alarms. The location of a specific person may also be defined by a specific cell of a mobile telephone network being used by a mobile telephone associated to this person. Further, geographical information like the Global Positioning System (GPS) coordinates may be used to identify the location of this person.

Radio network events may preferably be signals or calls from a radio network.

An event may also be a keyword typed in by a caller accessing the telecommunications web site or a password, used to identify a caller or to transmit certain information on access permissions of this caller to the host of the telecommunications web site. Further, an event may be a login event, i.e., a signal indicating that somebody is attempting to login or accesses the telecommunications web site.

An event may also originate from electrical instruments that may preferably be connected to a network. Thus, this electrical instrument may send signals to the telecommunications web site which can be identified by the event identification element. Such signals may be related to the status of the electrical device, for example, the ringing of a door bell, the use of tap water, the filling status of a reservoir like a water reservoir or the tank for petrol of a vehicle, a surveillance system for burglar alarms, a signal of an empty fridge, garage doors, climate surveillance systems for instance for showrooms, museums or wine cellars.

These events may be transmitted via a network, such as a UMTS network, an Internet-based network or a radio network.

An event may be the status of a telecommunication device such as a telephone. Thus, there may be four different events from, for instance, a telephone such as (a) the receiver is lying on the cradle, (b) the receiver is being picked up, (c) the receiver is off-hook or (d) the receiver is being hung up. These two states and two state changes of the telephone may then be four different events detectable by the event identification element of the telecommunications web site. Further, divers PSTN signals are preferably events being detectable by the event identification element. Thus PSTN signals are for instance signals like e.g., ISDN signals via D-channel, SS7 signals, UMTS or mobile telephone signals. Other possible signals are DTFM signals.

Video signals may be used as an event, especially with surveillance systems. Thus, it may be detectable by the identifying element as an event that a certain picture surveyed by a video camera may alter. For instance, it may be detectable that a video picture of a pigeon stable shows the arrival of a specific pigeon. Thus, this information retrieved by the video camera and an associated computer device may be transmitted to the telecommunication web site. This incoming event is identified by the event identification element of the telecommunications web site. Further, other information of a specific site surveyed by a video camera may be programmed to initiate an event transmitted to the telecommunications web site, for example the weather situation, the status day or night, satellite pictures, the tide of the sea, the pollution of a beach, infrared heat pictures and all information resulting from the alteration of a video signal.

Other signals, such as signals from ultrasonic surveillance systems or sensors like temperature sensors, etc., may be used as an event capable of being identified by the event identification element of the telecommunications web site. Further, the status of a switch, especially a switch associated to the desk the host of the telecommunications web site is working at, may be used as an incoming event. By activating the switch, the host may initiate an event transferred to the telecommunications web site detectable by the event identification element. Further, special keys on the keyboard or shortcuts in a software program may be used which are detectable by the event identification element of the telecommunications web site. Buttons that can be fixed to the monitor of the user of a telecommunications web site or to the desk or to the telephone may be used. Thus, the user may control the telecommunications web site even more easily by pushing or activating these buttons.

Thus, events that may be monitored can be transmitted to the telecommunications web site that is adapted to detect and analyze these incoming events using the event identification element.

In an embodiment of the present invention, the telecommunications web site is adapted to process information in a manner depending on the kind of event identified by the event identification element. Such processing of information may be the creation of an outgoing event or an internal event or the storage of information or data. Especially preferred, the telecommunications web site is adapted to process information that leads to establishing a communication between two parties. Further, the processing of information can be the deleting of a file infected by virus or the virus itself, the switching on or of the telecommunications web site at a certain time or date or especially preferred the establishing of communication to another device or party.

By identifying the incoming or internal event, the telecommunications web site may establish the desired communication in a predefined manner depending on the kind of event identified by the event identification element. This may include the telecommunications web site establishing the communication via a specific network or a specific device, etc. It may also include the telecommunications web site initiating a specific notification or alert or signal to be sent to the host of the telecommunications web site or a predefined group of different other users. It may also include the telecommunications web site not establishing a communication at all but rather storing certain information for further use. It may also be desirable to have the telecommunications web site wait for a cluster of events to be identified within a certain time period and then take steps predefined, for example, by the host of the telecommunications web site. Thus, the telecommunications web site may be adapted to detect and identify certain events of a fax to be sent from a certain number and a date and time criteria set by the host and an SMS message to be received as well as the information that a certain person is present in a certain room before the telecommunications web site initiates a certain predefined communication. For example, the telecommunications web site may be adapted and programmed by the host of the telecommunications web site to establish communication with person A as soon as a fax from a specific fax number is received, person A is sitting at a specific desk, the telephone status of this person A is not off-hook and it is before 10:00 p.m. on a certain date. Dependent on specific events or clusters of events, this communication may be established by the telecommunications web site.

In an embodiment of the present invention, the telecommunications web site allows for the creation of an event, especially a predefined event dependent from the event identified by the event identification element.

Thus, the telecommunications web site may initiate an outgoing event dependent on an incoming event. This outgoing event may be an event similar to the internal and external events described above. Further, the outgoing event may be an alert, a signaling, a notification, a messaging, the establishing of a communication, etc.

Signaling is an outgoing event that indicates in real-time that something is happening. Notification is the information that something is happening or already happened. A notification provides a description of the event itself. Messaging is an exchange of messages such as e-mail, SMS, etc. Thus, messaging is an exchange of content

In general, outgoing events may be of the same type or kind than the incoming events described above.

In an embodiment, the present invention provides a method to process information, in particular to establish a communication via a telecommunications web site, comprising the step of identifying an incoming event and processing information, especially establishing a communication, in a manner depending from the kind of identified event. With such a method, a communication may be established via a telecommunications web site more efficiently and individually than it is possible with a telephone or an ordinary e-mail system. Identifying an incoming event preferably means to detect the signal of the event, to receive the signal and to analyze the signal. Preferably, the origin of the signal is determined. Thus, the event for instance carries the information from which part of the event identification element the signal comes from.

In an embodiment, the present invention provides a telecommunications web site wherein the telecommunications web site has an event creation element.

The event creation element may include a set of hardware and software consisting of one or more core engines that create events based on the current state of the system and rules for transitions to the next state of the system. In an embodiment the core engine is a common object request broker architecture (CORBA) service. In other embodiments the core engine could also be a service realized SOAP, http(s), Microsoft .NET, Remote Procedure Call (RPC) or any other architecture capable of distributed computing via networks.

In an embodiment of the present invention, the event creation element is adapted to create an event, such as one or more of: a modification of the layout of the web page of the telecommunications web site presented to the caller or the specific entity, display of retrieval information, presentation of a predefined functionality, sending information to a user, signaling of information, queries to the caller to (fully) identify the caller, internal/external feedback, notification, authorization, especially authorization to download data, any other events described above, starting a specific software, or a combination thereof.

Such an event can be a server-based or client-based event such as generating a letter by printing, putting into an envelope, stamping and placing in a post office, news data, stock exchange data, sending an indication that someone is calling the telecommunications web site, e.g., the ringing of an end user unit like a telephone, the signaling via a web browser-based software acoustically or visually. Such outgoing events from a client or a server could be generated as a time-based outgoing event. Such a time-based outgoing event is for instance a birthday, scheduled e-mails or any kind of messages, especially UMTS messages, anniversaries, etc. Further, events may be processed-based outgoing events. Such events could for instance be the result of calculations of data, the result of a search within databases or the Internet, the result of comparison of information, comparison of documents, etc. In addition, the events could be based on incoming events. For example, such incoming-based events may be programmed expectations or scheduled expectations of incoming events or a combination of incoming events, which will automatically create outgoing events. For instance, the arrival of a fax in combination with the status of the home fax being busy will send an outgoing event to redirect the fax to another fax machine or to the fax storage. Thus, the event of the incoming fax, as well as the event of indicating that the home fax is busy, together are the event to redirect the fax. The event may be a cluster of events, especially of different classes. Thus, any combination of events can be used. With this combination the use of different services like for instance services of a telecommunication portal and very individual settings can be used. Thus, an outgoing event may be an UMTS message with a warning for closing the windows as soon as news were received from the telecommunication portal including the word “storm” and within a given timeframe there is an incoming weather forecast fax. As a result, very individual outgoing events can be defined dependent on very individual clusters or combinations of (incoming or internal) events. The outgoing events may include the same kind and types of incoming events, especially signaling, notifying and displaying of SMS, e-mails, faxes, voice messages and any other types of messages. Further, there may preferably be timer-based or automatic actions, for instance, sending of an absence notification. In addition, outgoing events may be uploading data in a database, transmitting information to another server/client or a specific end-user unit.

An event may be a notification, signaling, alert, etc., as described above with respect to the incoming events. Further, an event may be the kind the telecommunications web site is displayed to a visitor or caller. Thus, a display associated with the telecommunications web site may be modified by an outgoing event created by the event creation element. For instance, the telecommunications web site presented to a caller may display only specific content or options to communicate with the host of the telecommunications web site. In this case, a respective event created by the event creation element modifies the layout of the telecommunications web page displayed to the visitor and for instance allows only for fax and e-mail correspondence. Another event may modify the display of this layout by opening a window asking the visitor to confirm the authorization to access the web page of the telecommunications web site by entering a password or a keyword. Such a keyword may be a topic which again may lead to another event modifying the layout displayed to the visitor exactly to display the content of the topic identified.

The event may also be an event that modifies the layout presented to the host of the telecommunications web site. The web page presented to the host may for instance be modified to show the old correspondence with a person calling the web site. Thus, the event creation element modifies the layout of the web page presented to the host of the telecommunications web site by showing the old correspondence with a person that is in this moment calling the telecommunications web site. Such retrieval information to be displayed may also include additional information on the person calling, historic data information such as all events, reports of all communications and the like, as well as the link to this information. Such retrieval information is preferably stored in an individual protocol database, which may be integrated into a telecommunications web site.

In an individual database, personal data, specific filters, for instance blacklists to avoid calls from certain parties, groups of users, addresses and telephone numbers may be defined and stored. Further, the data may include data on contract details, billing information or accounting specification. Such an individual database may also be integrated into a telecommunications web site.

Further, an event may also be the presentation of a predefined functionality of a web page of the telecommunications web site. Such a predefined functionality may be the option to forward an incoming call to another end user unit or telephone number. Such a forwarding function could be provided by a button displayed on the layout of the web page. The event would then trigger the web page to alter its layout and to show this button or to activate this button with this certain functionality. For example, on an incoming call, the event creation element may create an event to activate a forward button for an incoming call. The host of the telecommunications web site may then be able to select and push this button (preferably on a browser-like software) and thus to forward the call to a predefined number. Other functionalities may include updating of the databases, exchange of files, especially MP3-files or picture files, hanging up on a specific caller, redirecting a call to an answering machine, etc. Further, information may be retrieved to start a program stored and installed on a server or a client. This information may be updated. For example, a specific word processing software may be loaded when a call from a party is received and information is retrieved that this party uses that word processing software.

An event may be initiated which updates data between the caller and the host of the telecommunications web site. For instance, such data may be personal data like address changes of both parties, even the transfer of entries of address books, MP3 files or picture files to be exchanged, etc.

A cluster of events may be created by the event creation element. With a cluster of events, several events independent from each other may be initiated and created that may in this combination carry out several functions. For instance, it is possible to create a cluster of events to notify the host of the telecommunications web site that a specific person called, to redirect this person to a specific predefined number, to modify the layout of the web page of the telecommunications web site presented to this specific caller, to store specific protocol data into the individual protocol database, and to inform a third party of this call. Further, the cluster of events may include a group notification of a group of users or the forwarding of this call to a group. This forwarding can be effected via fax, e-mail, SMS, voice message, data, etc. If a person calls via telephone, this call may be recorded and transformed into text that can be forwarded using a fax, an e-mail or a text file.

The telecommunications web site may also have an event identification element. Such a telecommunications web site may have the advantages of both an event creation element and an event identification element. Thus, dependent on the identified event, outgoing or internal events created by the event creation element may be initiated. Thus, the combination of both the event creation element and the event identification element allows for using both events as criteria for the telecommunications web site to react to incoming or outgoing calls.

The telecommunications web site may be adapted to allow for the predefined event created by the event creation element dependent on the identity of the caller and/or the incoming event identified by the event identification element.

In an embodiment, the present invention provides a communications environment comprising at least one telecommunications web site according to the present invention. The communications environment may comprise at least one telecommunications web site on a telecommunications portal.

In an embodiment, the present invention provides a method to create an event (especially establish a communication) via a telecommunications web site comprising the steps of: identifying an incoming event; creating an outgoing event; and establishing the communication in a manner depending on the kind of the identified event.

In an embodiment, the present invention provides program code portions for carrying out the steps according to the method of the invention.

In an embodiment, the present invention provides a telecommunications web site wherein the telecommunications web site has a caller recognition element. With such a caller recognition element, the caller of a telecommunications web site may be identified. For instance, this can be achieved by receiving and interpreting an ISDN signal related to the telephone number of a telephone calling the web site. A database storing the information of the telephone number may be used to identify the person behind the telephone number. On the other hand, more complex interpretation of more than one signal may be employed in order to recognize and identify the calling party.

In an embodiment, the caller recognition element is adapted to use information in a database to recognize a caller of the telecommunications web site. Such a database may store information on telephone numbers associated to certain parties, store information on historic data of the owner of the telecommunications web site such as a history of former calls, the kind of end user unit used by the calling party, the time and date of the call, etc. Altogether, this data forms a profile of the specific calling party. Such statistic data or retrieval data may be used to identify the calling party. The database may comprise an individual database (personal data, black lists, groups, etc.) and/or an individual protocol database (historic data). Further, biometrical data, personal identification numbers, IP addresses may be stored in such an individual protocol database. The IP address may be included where a voice-over-IP connection is to be established. Further, the IP address may be included where the end user unit used by the calling party has an IP address of its own.

The retrieval and/or statistics database may be an expert system. Such an expert system is adapted to learn from former events and may draw conclusions with respect to future events fitting into a certain set of parameters. Such an expert system is a computer application that performs a task that would otherwise be performed by a human expert. For example, there are expert systems that can diagnose human illnesses, make financial forecasts, and schedule routes for delivery vehicles. Some expert systems are designed to take the place of human experts, while others are designed to aid them.

Such an expert system may be part of a general category of computer applications known as artificial intelligence. Such an expert system may be implemented by a knowledge engineer, an individual who studies how human experts make decisions and translates the rules into terms that a computer can understand.

The most widely used knowledge representation scheme for expert systems is rules (sometimes in combination with frame systems). Typically, the rules won't have certain conclusions—there will just be some degree of certainty that the conclusion will hold if the conditions hold. Statistical techniques are used to determine these certainties. Rule-based systems, with or without certainties, are generally easily modifiable and make it easy to provide reasonably helpful traces of the system's reasoning. These traces can be used in providing explanations of what it is doing.

Expert systems have been used to solve a wide range of problems in domains such as medicine, mathematics, engineering, geology, computer science, business, law, defense and education. Within each domain, they have been used to solve problems of different types. Types of problem involve diagnosis (e.g., of a system fault, disease or student error); design (of a computer systems, hotel etc); and interpretation (of, for example, geological data).

Data for the expert system may originate from the communications data of the user of the telecommunications web site and/or data from the telecommunications portal. Such data from the telecommunications portal may include information originated by the services and resources of the telecommunications portal, warning lists, etc.

The caller recognition element may be adapted to progressively recognize a caller of the telecommunications web site. With such a weighted or graded recognition, several pieces of information may be combined to even more ensure the identity of the calling party. This information or data may be combined one after the other thus increasing the probability that the identity of the calling party is recognized correctly.

The caller recognition element may be adapted to parallely use information to recognize a caller of the telecommunications web site. Thus, different pieces of information may be used at the same time to recognize a calling party. Most preferably, the data will be used progressively and parallely as well. With a combination of these two approaches, the calling party may be recognized quickly and with a high hit rate. For instance, the caller recognition element may use data originating from the device used by the calling party, may compare this data to data in a historic database of former calls and parallely retrieve data on the date and time of the call and compare this to data in the historic database as well.

The caller recognition element may be adapted to use passive information such as type of calling device, type of software used by the caller, especially type of browser used by the caller, provider of the caller, time and date of the call, place of the caller, for example the GPS coordinates of the caller, configuration of the device of the caller, for example the computer configuration of the caller, type of processor used, operating system, IP-address, UMTS address, ISDN address, telecommunications web site information, telecommunications portal information, random access memory (RAM) configuration, hardware configuration or a combination thereof.

The caller recognition element may be adapted to use proactive information like cookie information, information of a telecommunications web site, information of a telecommunications portal, information of a user-tracking software or a combination thereof.

The caller recognition element may be adapted to use interactive information such as a password entered, a subject or a keyword entered, data on a chip-card, biometric information, such as voice data, fingerprints, structure of the eye, spectrum of the skin, genetic information or a combination thereof.

The caller recognition element may be adapted to determine a probability of the caller being the identified caller. With such a probability, the telecommunications web site may then provide rules that refer to this value of probability. This probability may be displayed to the host of the telecommunications web site. It may be in the host's discretion to act according to the displayed information.

The telecommunications web site may have an event identification element and/or an event creation element. Thus, the telecommunications web site may benefit from the combination of all these elements. The telecommunications web site may also comprise an individual event settings element. Thus, data used when identifying a calling party may be identified by the event identification element and then passed to the caller recognition element. Further, the caller recognition element may pass a value of the probability of the identity of the calling party to the individual event settings element. This element may include a database which provides a rule processed dependent on the value of this probability and then passes a signal to the event creation element to create an event according to the applied rule

The telecommunications web site may allow for an event dependent on a probability, determined by the caller recognition element, of the caller being the identified caller. Such a predefined event may be an internal event such as a modification of the display of the telecommunications web site or an outgoing event such as a signaling or notification, or the display of an input box, to the calling party to request that the calling party (fully) identify itself.

In an embodiment, the present invention provides a communications environment, comprising at least one telecommunications web site with a caller recognition element. The at least one telecommunications web site may be provided on a telecommunications portal.

In an embodiment of the communications environment according to the present invention the telecommunications web site is adapted to provide for private communications in a manner depending from data characterizing the first end user unit. Thus, the telecommunications web site can establish a communication dependent from the specific end user unit employed to establish the contact. If a telephone is used as first end user unit, the telecommunications web site may provide for the specific entity to establish a communication with another telephone or a mailbox, etc. If the first end user unit used is a fax machine, the telecommunications web site may provide for the specific entity to establish communication with another fax machine, scanner, computer, etc.

In an embodiment of the communications environment according to the present invention, the manner of the private communications and/or the data characterizing the first end user unit is predefined by the specific entity. Thus, the specific entity can predefine how the telecommunications web site may react to a specific type of end user unit. As a result, the communications environment can be personalized and defined more specifically to the needs of the person behind the specific entity, i.e., the host of the telecommunications web site.

In particular, the specific entity may define its own individual telecommunications web site including, for example, indications which data are to be provided via the telecommunications web site to which accessing end user unit, how communications links are to be or can be routed to an accessing end user unit (e.g., via the Internet or a telephone network), the handling of received communications (e.g., returning delivery confirmations or response communications) and security constraints (e.g., which kind of communications are allowed, what type of network is to be employed by the accessing end user unit, and which communications formats and protocols are to be used).

Further, the calling party may be permitted or required to input a password to fully confirm the identity of the calling party.

In an embodiment, the present invention provides a method for identifying a calling party of a telecommunications web site comprising the steps of: receiving a signal of an incoming call; retrieving data from a database, for example using data from the telecommunications web site (such as time and date) and/or using data from the signal of the incoming call and/or using data from an event identification element and/or using data originating from passive information and/or proactive information and/or interactive information; and using data progressively and/or parallely, determining the probability of the call being originated by a certain party. Thus, it is possible to identify a calling party even if the caller is using a personal computer or a browser software.

The method may further comprise the step of having the calling party enter a password to confirm the identity of the calling party. Thus, it is possible to fully identify the calling party on request.

The method may further comprise the step of creating an event dependent on the determined probability of the call being originated by a certain party. Thus, it is possible to react individually to a specific calling party. For instance, the layout of a “welcome page” of the telecommunications web site may be altered to reflect content suitable for the identified caller.

The method may further comprise the step of creating an event dependent on predefined individual event settings. Thus, events may be used that are stored before the contact.

In an embodiment, the present invention provides a telecommunications web site that has an individual event settings element. With such an individual event settings element it is possible to define rules and to store these rules. These rules refer to events to be created dependent from certain parameters available for the telecommunications web site.

Such rules may include any incoming, internal and/or outgoing events combined logically. A user-defined schedule, serving as a condition to trigger any combination of events is feasible as a rule. Rules may define events that are to be created as soon as certain sets of criteria are satisfied. Such sets of criteria may include any combination of events connected to each other. These events may be connected in a rule via logical operators like AND or OR or NOT, etc. The user of the telecommunications web site may define these rules of the individual event settings element. For instance, the user may define the following rule: check the phone bill after terminating any phone call. If the phone bill exceeds EUR 1,000 then notify me via SMS to a certain number. Thus, the termination of the phone call is an outgoing event triggering the telecommunications web site to check on the phone bill and then to determine whether the phone bill has exceeded EUR 1,000 or not. In the first case, an SMS notification is sent to the user.

The individual event settings element may be a database application installed on a computer device such as a server. Here, all data and information on the individual settings and rules may be stored.

The telecommunications web site may have a caller recognition element and/or an event identification element and/or an event creation element. With these elements, the telecommunications web site may use a large variety of different incoming events to serve as parameters in the rules. Any of the incoming events mentioned above may be parameters. A variety of incoming events may be combined, for example, using logical operators. In the individual event settings element the rules may be stored and processed, i.e., evaluated against any new event to ensure that any time a rule is satisfied, the corresponding outgoing event is created. Further, various kinds of creatable outgoing events may be defined. These events may include events directed to or coming from a portal, such as a telecommunications portal. Further, these events may refer to a UMTS network.

In an embodiment, the present invention provides a communications environment, comprising at least one telecommunications web site with a caller recognition element, especially when comprising at least one telecommunications web site on a telecommunications portal.

In an embodiment, the present invention provides a method for identifying a calling party of a telecommunications web site comprising the steps of: identifying an incoming signal in an event identification element; passing this signal to a caller recognition element; identifying a calling party originating the incoming signal using data stored in databases of the telecommunications web site; passing the data on the identity of the calling party to an individual event settings element; determining rules from the individual event settings element that satisfy the given parameters; and creating an event in an event creation element dependent from the rules determined.

In an embodiment, the present invention provides a telecommunications web site wherein there are various zones provided for a layout, such as an output layout, of a web page of the telecommunications web site. These different zones of the layout may facilitate organization of the magnitude of information that can be used and controlled by a single telecommunications web site. Thus, with several zones in a layout of a telecommunications web site, the telecommunications web site is easier to handle and to control. Such zones are preferably areas in a layout presented to the visitor of the telecommunications web site, either as a calling party or as the host of this telecommunications web site.

The zones may include a signaling zone and/or a real-time zone and/or a controlling zone and/or a settings zone and/or an interactive zone and/or a personal data zone and/or a personal portal zone and/or a personal homepage zone and/or a video conferencing zone.

The signaling zone is a zone in which the status of the connection may be visualized. Thus, the signaling zone may comprise tags to be displayed in the signaling zone giving the status of a certain connection. For example, the signaling zone could display tags like “pre-call is being established . . . ”, “connecting . . . ”, “no connection”, “dialing”, “call waiting”, “knocking”, “on hold”, “retry in x seconds”, “retrying”, “forwarding”, “talking to answering machine”, etc.

Further, the signaling zone may comprise optical elements like a colored flashing area indicating that somebody is calling, using different colors for different states of the connection, etc. For instance, a yellow light may blink in the signaling zone when a call is waiting, a green light may be used when a connection was established, etc. Preferably, the signaling zone is just one line of text high.

Further, the telecommunications web site of the present invention may include a real-time zone. In the real-time zone, actual data being processed at a given moment can be displayed. For instance, the person calling the web site may be displayed with the name and the calling telephone number. Further, a status may be given. The status may be “online”, “disconnected”, “on hold”, “in conference”, “mute”, “offline”, “connected”, etc.

Further, the real-time zone may comprise several buttons offering certain functionalities like “connect to”, “add to conference”, “show history”, “add to contacts”, “send message (e-mail, SMS, UMTS message, etc.), “invite to chat”, etc.

Further, the real-time zone may display information on waiting calls, conference call members, etc.

At least one of the zones may be a controlling zone. With such a controlling zone additional information can be displayed which may be used to establish a connection. Such information may include addresses, especially address lists, most-used addresses, addresses of people that are currently online, groups of addresses like family, friends, colleagues, etc. Further, the controlling zone may comprise functionalities displayed preferably by a button. Preferred buttons are buttons showing the online status of the party connected to the telecommunications web site, opening a chat window, a button to show certain communication partners that were contacted most frequently by the user of the telecommunications web site, i.e., a so-called “show most used”-button, a button showing communication partners who are online, i.e., a so-called “show online”-button, a button showing groups of communication partners, preferably predefined by the user of the telecommunications web site, i.e., a so-called “show groups”-button, a button on which the most recently used communication partners are displayed, i.e., a so-called “show most recent used”-button, other buttons to select the person to be called, for instance a “jump to (ABC)”-button, by which persons can be selected according to the alphabet, a button with which a new contact or address can be added, removed or contacted, a button to sort data entries like for instance the table of the history, i.e., the data entries of former contacts to a certain person or all the persons contacted. Such sorting may provide for sorting by different data fields like type, from, to, subject, date, etc.

Further, the zones may include a settings zone. In such a settings zone the rules of the individual event settings element may be defined. Such a settings zone may comprise functionalities such as time-based change of user profiles, preferred number of the host of the telecommunications web site, caller-based change of user profiles, etc. The profiles may contain any rule/action to effect an automatic virtual operator function. Such a “virtual operator” function may enable the user of a telecommunications web site to define rules that make the telecommunications web site to act like an operator. For instance, the user may define to redirect calls from a certain party to a specific mobile telephone within the next two hours whereas all other calls are redirected to the mailbox. Thus, the settings may be chosen and function similar to instructions for a secretary managing the communication of the user.

An interactive zone may be provided in a telecommunications web site. In such an interactive zone or messaging zone or exchange zone files may be exchanged between the calling party and the host of the telecommunications web site. It may be possible to offer the exchange of files like MP3 files, picture files, text files, etc. Further the interactive messaging zone may be used as a “whiteboard”. Thus, in the interactive zone the user can draw and paint using predefined forms like rectangles, triangles, circles or paint free-hand style scribbling something in the interactive zone leaving it to the other party to interpret the meaning of this painting. Most preferably, the parties connected via the telecommunications web site may use the interactive zone to jointly use programs, especially software programs like word processor software, spreadsheet software, etc. The parties may also choose to watch movies in the interactive zone or listen to music, for instance from MP3 files. Further, the parties may choose to use the interactive zone to chat and input text via their keyboards.

The zones may include a personal data zone. Files of the user or the host of the telecommunications web site may be stored in the personal data zone. In these personal data zones, friends or people with access to the telecommunications web site may display or store data files or documents. The parties may use the personal data zone to exchange MP3 files, pictures, any user documents, etc. The personal data zone may be used to define and set special rights for different users and user groups to access these files, to read, to amend, to write, to edit, etc. these files as well as the folders used to organize these files.

The zones may include a personal portal zone. In this personal portal zone, the user of the telecommunications web site may display data and content of services that are available via the telecommunications portal. For instance, the host of the telecommunications web site may display the latest news on a soccer game, stock market information, etc. on this personal portal zone. Further, the information or services available via the telecommunications portal may include the following information and/or services: Advanced search: Internet search for information using advanced search functions; Search: high-speed search of the entire directory of a portal for a search word; Directory: (German language) web pages edited and sorted by more than 36,000 categories; Communication Chat: chatting, flirting or obtaining information—with WEB.DE Chat; FreeMail: free e-mail, fax, SMS, voice messages, telephone calls via the Internet; Mobile phones: allows for downloading of logos, ringing tones, test reports, etc. for mobile phones; Calendar: a handy meeting and task organizer; Newsgroups: about 1,200 German news groups, clearly sorted; SmartSurfer: access to the Internet using the cheapest rate; TrustCenter: encoding of mails and digital signature guaranteeing a safe use of the Internet; WAP: extensive WAP directory, access to WAP services and important information; Wake-up call: wake-up call at a predefined time; Aktie.web.de: obtaining information on WEB.DE shares and the Company; Stock market: up-to-date stock market information, share indices, share performance comparison etc.; Soccer tips: free price draw with attractive prices for the German premier league; Horoscope: finding out about the future; Reporter: up-to-date, regular and individually tailored news via e-mail-; Headlines: the most important news items and topics of the day; Sport: the entire world of sports, covering everything from soccer to tennis, to Formula I and much more; TV Program: providing quick overviews and the weekly program; Weather: up-to-date weather reports including forecasts on pollen counts, ozone and UV-levels; Entertainment Comics: daily comics and cartoons of all varieties, also for e-mail distribution; Greeting cards: greeting cards, poems and jokes for every occasion and every taste; Logos & Ringing Tones: Customizing a mobile with logos and ringing tones; Lottery-by-Mouse-Click: the daily chance to become a millionaire—free!; Radio: the best hits on the Internet, plus links and interesting tips on surfing the net; Roadwork Service: up-to-date information on work on roads and highways; Download: providing more than 17,000 programs for 10 platforms; Registration Service: registering an e-mail in the WEB.DE directory; Protection of Minors: protecting all web sites with erotic content from unauthorized access by minors; MyShirt: ordering T-shirts or the like with a print of your FreeMail address or a design of your choice; Route Planner: Europe-wide route planner with important additional information; Traffic Jam Alert: up-to-date information on locations and extent of traffic jams; WEB.DE Lottery Service: 24-hour lottery service; Web-Guide: interesting information concerning the Internet for both beginners and experts; Consumer Subscription Service: the intelligent way to subscribe to your favorite magazine; Catalogues: 1,500 catalogues at your fingertips; Paybox: shopping online and pay via mobile phone—safe and easy; Installment credits: comparing credit terms of various credit institutions; Shopping: allowing for online shopping and includes guidelines on online shopping and online law; Telephone rates: the ultimate tool for finding the cheapest telephone rates.

Further, the zones may include a personal homepage zone. On this personal homepage zone the host of the telecommunications web site may present his own homepage either by link or with a full content. On this personal homepage content and functions that can be found on homepages built with HTML may be displayed, i.e., pictures, text, macromedia flash elements, lyrics, reviews, public chat, link collections, animations, movies, MP3 files, games, Java applets, Java programs, Java script functionality, etc.

Further, a video conferencing zone may be provided on a telecommunications web site. With such a video conferencing zone it is possible to show the people taking part in a videoconference. The pictures of the people may be arranged in a row in the video conferencing zone. Thus, it is possible to integrate the members of a videoconference very easily by using a telecommunications web site.

The video conferencing zone may be adapted to provide for a zooming function. With such a zooming function the user of the telecommunications web site may choose to zoom in or out specific persons taking part in the videoconference. Thus, it is possible to enlarge the picture of a specific partner in the videoconference. The video conferencing tool may be adapted to automatically zoom in on the person that is speaking at the moment. Thus, it is easier to follow the videoconference talk since the image of the person speaking at the moment is enlarged. Further, the persons may be displayed in a highlighted way. Such highlighting may be a frame, colored background, blinking, etc. Thus, the user of the telecommunications web site may easily distinguish the person speaking from the rest of the participants in the conference talk.

The telecommunications web site may be adapted to present a layout comprising different zones with different content to different calling parties of the telecommunications web site. Thus, the telecommunications web site may differ from the content with respect to the different calling parties. Thus, a calling party may see exactly the information that the host of the telecommunications web site sees fit for this specific calling party. For instance, the host of the telecommunications web site may choose to display only the business contact information and the position of the host in the firm when a person belonging to a predefined “business group” is calling. However, if a family member calls in, the same host may have decided to display a more personal content and offer to download the pictures of the last holiday, for example. Thus, the host of the telecommunications web site is enabled to show “different faces to different people”. In addition, the different zones may have completely different content in case the host himself is calling the telecommunications web site. In such circumstances, the telecommunications web site may display much more functionality and information than to any other calling party of the telecommunications web site.

The telecommunication web site may be adapted to modify the layout as a response to an event. With the event and time triggered modification of the web site it is possible to answer the ongoing caller recognition or any other event. If a calling party is not yet fully recognized, a minimum of content and/or functionality may be displayed to the calling party. As soon as other events are recognized, identifying for instance a calling party, more individual data for this calling party may be displayed. If for instance an unidentified calling party accesses the telecommunications web site a blank page with only one button to hang up may be displayed. However, the more information the retrieval system gathers about the calling party, the more information can be displayed on the different zones of the telecommunications web site layout. In the end, a window may be displayed to the calling party to confirm their identity by entering a password or answering a specific question that only people from a certain group can know. As a result, the calling party may be presented with the full content that the host predefined to be displayed to a member of this group or this particular person.

In an embodiment, the present invention provides a communications environment, comprising at least one telecommunications web site with a caller recognition element. The at least one telecommunications web site may be provided on a telecommunications portal.

In an embodiment, the present invention provides a method using a telecommunications web site adapted to allow for inputting data, for example to a web page of the web site, wherein the inputting of data is writing, drawing, painting, typing, pushing a button, talking, uploading data or a combination thereof. With the inputting of data into the telecommunications web site, interaction between the parties using this telecommunications web site can be accomplished. Thus, parties may communicate and interact via the telecommunications web site. The inputting of data may be accomplished by touching, for example by touching a screen.

Writing can be accomplished by using a pen. This pen preferably is connected to the input media or end user unit like a painting pad. From there, the writing, preferably with a specific pen, is transmitted to an input media like a computer device displaying all movements of the pen on this drawing pad directly on the screen.

Drawing may include inputting data other than written text, such as figures, drawings, specific forms, freehand drawing, etc. For instance, a party communicating via the telecommunications web site with another party may draw a scheme of how to access a specific site, in the manner of a hand-drawn map. The inputting tool for drawing on the telecommunications web site may also offer a tool for inputting specific forms for drawing automatically. Thus, the party inputting a drawing may choose to use a rectangular form or a circle or a triangular form, etc. With this form the party may choose the size of the form to be drawn and moreover may use this form in the telecommunications web site immediately.

“Painting” may be used to input data into a telecommunications web site. With painting freehand style schemes and sketches, a party communicating via the telecommunications web site may easily use figures and drawings made by hand to illustrate certain information which would otherwise have to be expressed in a more time-consuming manner. Colors may also be usable to illustrate certain aspects of these drawn painting figures.

Typing may be used to input data in the telecommunications web site in order to communicate with another party. When inputting data via a computer device, typing text into a keyboard is a common, easy way to input text into the telecommunications web site. Further, special keys on the keyboard may be predefined to allow for certain functionalities that can be executed by pressing only one key. Also, short keys can be used where a combination of keys to be pressed on the keyboard allow for certain other functionalities or special symbols. For instance, a key may allow for inputting a footer or a predefined form letter into the inputting area of a telecommunications web site.

Further, pushing a specific button may be used to input data into a telecommunications web site. Such a button may be a switch on the desk of the user of the telecommunications web site. Such a button may be programmed to allow a certain functionality to be executed. Such a functionality may be a simple “yes” or “no” to be input to another party via the telecommunications web site and thus allow for a very fast and effective way of communication where only short decision are necessary as for instance when placing an order on the stock market, etc.

Talking may also be used to input data into a telecommunications web site when communicating. The words may be transformed into text and this text input and displayed on the telecommunications web site. Thus, a person may choose to use a voice recognizing system to input data into the telecommunications web site. This voice recognizing system may be installed on the telecommunications web site, allowing the parties to input data by talking.

Uploading of may also be used to input data into a telecommunications web site. Thus, prepared text files or MP3 files or PDF files, etc.—any data containing files—may be uploaded and input into the telecommunications web site. Thus, the telecommunications web site allows for presentation of prepared documents or other data files to the other party. Such files may include drawings, text, music data, picture files, etc. Other ways of inputting data may be the use of joysticks, trackballs, a mouse, pedals, a special telecommunications web site keyboard, electronic instruments (e.g., synthesizers, keyboards).

The inputting of data may be accomplished bi-directionally, i.e., inputted by both parties communicating with each other over the telecommunications web site. Thus, the data may be input by each party and transmitted to the other party, similar to a conventional chat. The data is not only put into the telecommunications web site but also transmitted to the other party. Thus, it is possible that both parties may write and edit a certain text and then exchange the text files via the telecommunications web site. It is also possible to have a communication via a telecommunications web site as in an ordinary e-mail communication—however, the communication takes place via the telecommunications web site and not via any mail server. Further, one party may choose to write into the telecommunications web site via a respective pad whereas the other party may choose to talk and input data via voice to the telecommunications web site. With this bi-directional inputting of the data both parties may choose their preferred way of inputting data.

The inputting of data may be displayed in real-time. With such a method the data may be transmitted and displayed to the other party immediately and thus allow for a conversation in real-time. One party choosing to input data by using a pad may be immediately presented with the answers of the other party that chooses to input data via voice. Thus, a real-time communication is established via the telecommunications web site. This displaying the data in real-time to the other party may be accomplished by a dedicated protocol for telecommunications web site client-server or client-client communication.

The inputting may be accomplished into one document at the same time. With this method it is possible that both parties can communicate referring to a specific document at the same time. For instance, both parties may be connected via a PSTN network using telephones via the telecommunications web site. Both parties may simultaneously have access to the Internet via a computer device and display a document to each other. While both parties discuss the content of this document via telephone, they may simultaneously highlight certain passages or paragraphs of the document in color and thus show the other party the specific detail in the document they are referring to. Thus it is possible to have documents on the telecommunications web site both parties can use to demonstrate and display to the other party. This is accomplished by providing this data file on the telecommunications web site. Thus, both parties may communicate as if they were using a document on the same table highlighting certain paragraphs and pointing out certain areas, for instance, a text file a picture file, a music file, etc., to each other. The parties may be able to display more than one document to each other. Thus, it is possible to refer to a certain specification as a text file and certain drawings as figures to explain certain aspects of a technical device. The document may be able to be highlighted by both parties but only edited and saved by one party. Thus, one party may have the power and authorization to alter the document whereas the other party may have read-only access to the document.

The inputting of data may be accomplished interactively. For example, a user may input data to the telecommunications web site in response to certain prompts or information from the site. The telecommunications web site may produce and display results in response to data inputs by the user, and the user may input additional data in response to the results. In other embodiments, two or more parties may input data to a document, view what the other party or parties have entered, enter data in response to data entered by another party, etc. With such interactive inputting of data both parties may edit, for instance a text file, simultaneously. Both parties may alter the text of the text file. This functionality is known, for instance, for text processor software in local area networks. Using the telecommunications web site, editing of documents is not limited to a specific word processor software and may be accomplished for various types of files. Thus, both parties may edit a specific text file, for instance in different chapters, simultaneously and add text to this file. Further, the parties may add music files, for instance MP3 files, to one data file or insert drawings, pictures, etc., to data files. Thus, each party may interactively edit a document without having to wait for the other party to grant access to this document. Such communication capability can enhance interaction between the parties. This is especially the case when such communication takes place in combination with the multi-media or multi-protocol communication, i.e., communication via different media or different protocols, for instance PSTN network, Internet, video communication, etc. At the same time this communication allows for complex and fruitful communications between parties. This way of communicating is not necessarily limited to two parties.

In an embodiment, the present invention provides a computer program product, including program code portions for carrying out steps according to any of the aforementioned methods. The computer program product may be stored on a computer readable storage medium or in a computer readable memory unit.

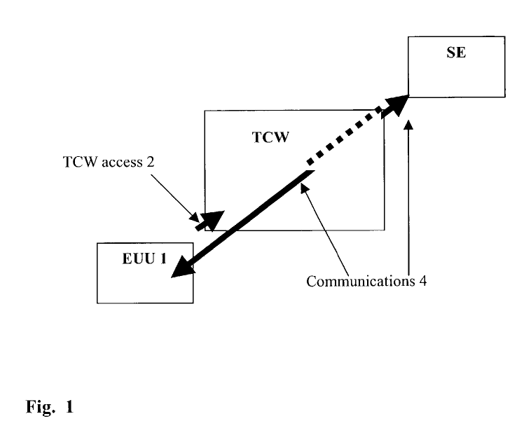

As shown in FIG. 1, first end user unit EUU1 accesses telecommunications web site TCW, as indicated by arrow telecommunications web site TCW access 2. In response to telecommunications web site TCW access 2, telecommunications web site TCW establishes private communications 4 with a specific entity SE. Private communications 4 are performed only between first end user unit EUU1 and specific entity SE; further parties cannot participate. As set forth above, telecommunications web site TCW serves as a general-purpose communications interface or “window” as illustrated in FIG. 1.

First end user unit EUU1 may be a single communications unit, such as a stationary/mobile telephone, fax device, computer system and the like. Further, in order to increase the communications capabilities, first end user unit EUU1 may include more than one communications unit which can be individually used or used in parallel for accessing telecommunications web site TCW and communicating via telecommunications web site TCW.

As opposing communications party, specific entity SE may be characterized as the entity with which telecommunications web site TCW is associated, i.e., telecommunications web site TCW is personalized for specific entity SE. For addressing specific entity SE and communicating therewith, telecommunications web site TCW is accessed by first end user unit EUU1 using an address-like identification uniquely indicating telecommunications web site TCW and, thus, specific entity SE. For example, a user of first end user unit EUU1 enters address information characterizing specific entity SE, e.g., a company or a person, to be contacted. On the basis of the provided address information, telecommunications web site TCW is accessed and establishes in response thereto the private communications with specific entity SE, e.g., the company or person with whom communications are intended by the caller.

For communications purposes, the specific entity SE can include a single communications unit, like a stationary/mobile telephone, fax device, computer system and the like. Further, in order to increase the communications capabilities, the specific entity SE can be comprised of more than one communications unit which can be individually used or used in parallel for communicating via the telecommunications web site TCW.

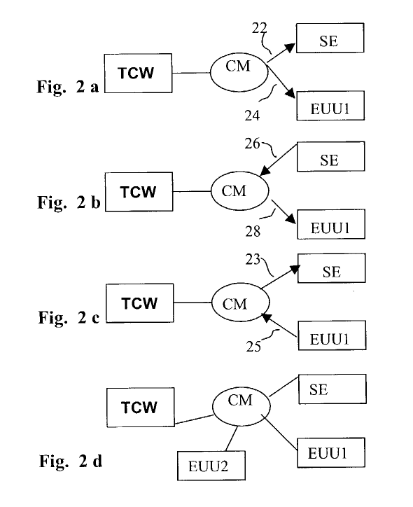

In FIGS. 2a to 2d, a first scheme of communication between specific entity SE and first end user unit EUU1 is illustrated. Telecommunications web site TCW has connection means CM available to it. Telecommunications web site TCW is connected to, and controls, connection means CM. In some embodiments, connection means CM may be integral with telecommunications web site TCW. Connection means CM may be an IP switch, an adapter, a gateway, etc. Connection means CM is adapted to provide and establish communication between specific entity SE and first end user unit EUU1.

With reference to FIG. 2a, telecommunications web site TCW may initiate, via connection means CM, a connection (arrow 22) to specific entity SE and at the same time a connection (arrow 23) to first end user unit EUU1. Both participants, specific entity SE and first end user unit EUU1, are then connected via telecommunications web site TCW, which controls connection means CM. For example, specific entity SE may access telecommunications web site TCW and request to establish communication between specific entity SE and first end user unit EUU1. Specific entity SE may use a telephone and first end user unit EUU1 may use a mobile telephone, for example. Telecommunications web site TCW now controls connection means CM to initiate a call to the stationary telephone of specific entity SE and to initiate a second call to the mobile telephone used as first end user unit EUU1. Further, the connection means CM connects both the call to specific entity SE and the call to first end user unit EUU1. The respective telephones of specific entity SE and first end user unit EUU1 begin to ring. The specific end user having initiated this call via the telecommunications web site TCW may now pick up his/her phone and be connected to first end user unit EUU1.

In FIG. 2b, specific entity SE is shown directly accessing (arrow 26) the telecommunications web site TCW via the connection means CM. The telecommunications web site TCW now establishes a connection (arrow 28) via connection means CM to first end user unit EUU1. Thus, specific entity SE as the calling party can connect to first end user unit EUU1 via the telecommunications web site TCW and connection means CM.

In FIG. 2c, first end user unit EUU1 is shown initiating the connection by calling (arrow 25) telecommunications web site TCW. The telecommunications web site TCW then initiates a call (arrow 23) to specific entity SE via connection means CM. Thus, first end user unit EUU1 is connected to specific entity SE via the connection means CM, which is controlled by the telecommunications web site TCW. With this embodiment according to the present invention it is possible for first end user unit EUU1 to directly connect to specific entity SE via the telecommunications web site TCW without knowing, or being concerned with, what sort of end user unit specific entity SE is using.

FIG. 2d illustrates communication between more than two participants. Specific entity SE may now initiate calls and connections via the telecommunications web site TCW to invite another end user using end user unit EUU2 into the call. Thus, functions like conference call, switching, forwarding, rejecting, parking, etc., may be effected. It may be the case that specific entity SE and first end user unit EUU1 are already in communications, when EUU2 calls specific entity SE via the telecommunications web site TCW. Specific entity SE may then choose to park first end user unit EUU1 and to talk to EUU2 while first end user unit EUU1 is on hold. Specific entity SE may then decide to invite first end user unit EUU1 into a conference with specific entity SE and EUU2. Thus, a communication between three participants may be established.

Telecommunications web site TCW may therefore work as a “virtual operator” using connection means CM and establishing a communication path between several participants of the communication. Specific entity SE, as the owner of the telecommunications web site TCW, may then decide which party to invite into the communication and which party to reject. Since connection means CM may include not only switches, such as IP switches or switches in the PSTN network, but also gateways and protocol translators, telecommunications web site TCW may be used as a virtual operator to establish a variety of types of communication connections.

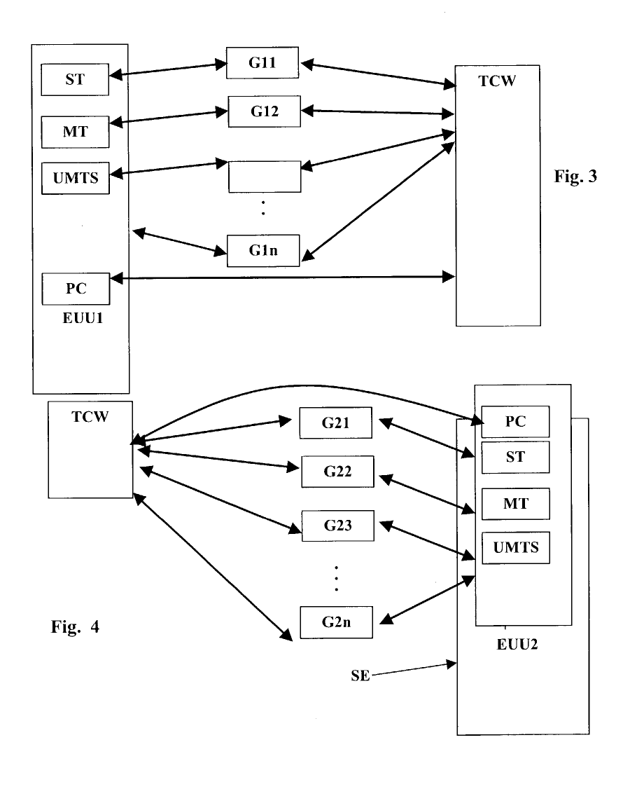

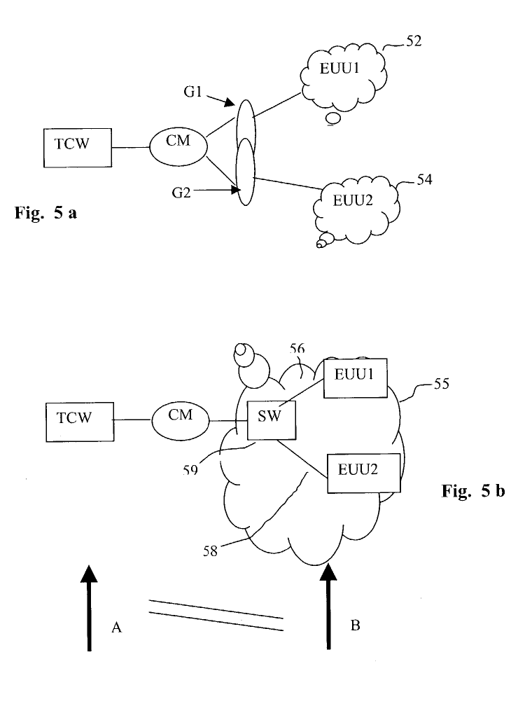

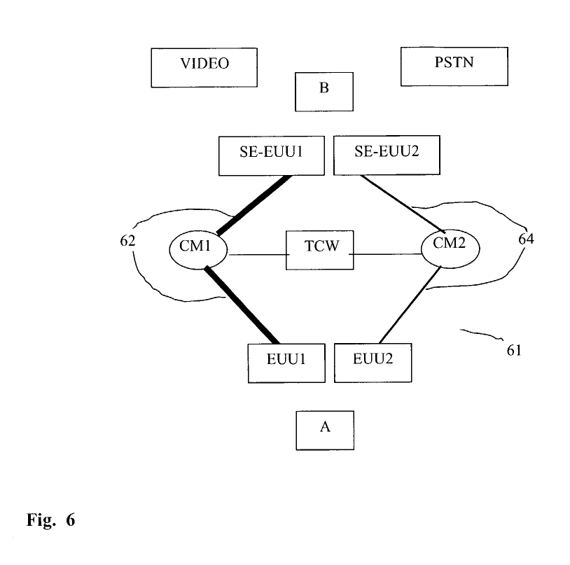

Reference may now be had to FIG. 3. For accessing and communicating via telecommunications web site TCW, first end user unit EUU1 may use a direct communications link, e.g., over the Internet in the case where both first end user unit EUU1 and telecommunications web site TCW are serviced by the Internet. Where first end user unit EUU1 is a communications unit adapted for and/or serviced by a network different from a network telecommunications web site TCW is connected to (here the Internet), respective gateways G11, . . . , G1n, as shown in FIG. 3, may be used.

In particular, gateway G11 is employed for accesses to, and communications with, telecommunications web site TCW where first end user unit EUU1 includes stationary telephone ST serviced by a PSTN network. Gateway G12 is employed where first end user unit EUU1 includes mobile telephone MT serviced by a mobile communications network. The number of gateways G11, . . . , G1n is not necessarily limited and may primarily depend on the type of first end user unit EUU1 and communications devices used.

In a comparable manner, as shown in FIG. 4, for communicating via telecommunications web site TCW with respect to specific entity SE, a direct communications link can be used. The direct communications link may be, e.g., over the Internet where both specific entity SE and telecommunications web site TCW are serviced by the Internet. Where specific entity SE is a communications unit adapted for and/or serviced by a network different from a network the telecommunications web site TCW is connected to (here the Internet), respective gateways G21, . . . , G2n, as shown in FIG. 4, may be used.

Gateway G21 is employed for accesses to, and communications with, telecommunications web site TCW where specific entity SE includes second end user unit EUU2 having a stationary telephone serviced by a PSTN network. Gateway G22 is employed where second end user unit EUU2 includes a mobile telephone serviced by a mobile communications network. Again, the number of gateways G21, . . . , G2n is not necessarily limited and may primarily depend on the type of specific entity SE used and the communications devices used.

For example, where both the calling party (first end user unit EUU1) and the called party (specific entity SE) communicate using a personal computer, they communicate via the telecommunications web site TCW of specific entity SE using a visual display on their personal computers which has the appearance of a conventional web page. In contrast to a conventional web page, however, telecommunications web site TCW is accessed by both parties at the same time: information inputted on one side will be displayed on the other side as it is being inputted. For example, in the case of text inputted by one party, the other party will be provided, on its display, the text as it is inputted by the transmitting party. Thus, in contrast to a conventional e-mail system, neither the sending party nor the receiving party is required to perform actions to transmit or receive, respectively, communications data.

Where both first end user unit EUU1 and specific entity SE communicate by telephone, communications will also be executed via telecommunications web site TCW. In view of the restricted information display capabilities of a telephone, i.e., in general only the transmission of voice data optional with low resolution graphic data, such communications will appear as a conventional telephone conversation optionally accompanied by visual information on one or both telephone displays—with the notable difference that communications are executed via telecommunications web site TCW.

Advantages of communications via telecommunications web site TCW are more evident for the case of communications between first end user unit EUU1 utilizing a telephone and specific entity SE communicating using a personal computer. For example, assume a calling user associated with first end user unit EUU1 intends to communication with a user associated with specific entity SE, here from a telephone to a personal computer. The calling user accesses telecommunications web site TCW of the user to be contacted by providing the respective address information via the telephone. In response thereto, telecommunications web site TCW connects to the personal computer of the called user and, thus, establishes a communications link between the two users. For actually communicating, both users utilize respective end user units, i.e., the telephone and the personal computer, in a conventional manner, while telecommunications web site TCW interfaces between the different types of end user units.

As a result, the telephone user will, in general, communicate with voice transmissions, while the personal computer user will receive communications in form of visual displays and transmit communications by inputting respective data into the personal computer. Optionally, the telephone user can operate keys of the telephone to input communications data and can be provided visual information on a display on the telephone. Moreover, the personal computer user can input and receive acoustic data if using respective units (e.g., microphone and headset). Nevertheless, the way both users operate the respective end user unit does not necessarily depend on the end user unit of the other party. Rather, both users operate their end user units in a conventional manner. In contrast to conventional communications, different technologies are merged without specific interaction required to be performed by the users.

With respect to routing of communications links, telecommunications web site TCW permits the use of different networks in parallel and/or in series to perform communications. For example, in the case of video conferencing, telecommunications web site TCW routes any data which can be visualized on a monitor over a data link suitable for video data (e.g., a computer/Internet-based network), while voice data will be routed over a telephone network. As a result, the participating parties benefit from the technical properties of the telephone network, which is optimized with respect to a transmission voice data, and at the same time benefit from the quality of visual data transmitted via a link designed for that purpose. Further, the participating parties are not required to control transmission links for different data/content. Rather, telecommunications web site TCW automatically selects, depending on the data to be transmitted, a suitable network. Since all data routing is automatically performed inside the communications environment, there is no need to use different end user units for data being transmitted via different communications links. For example, in the case of video conferencing, the participating parties can use personal computers equipped with a video camera and visual and acoustic display devices as integral end user units. The end user units may thus may transmit and receive integral communications. Despite the integral front end appearance of the communications, different communications types may be executed using separate respective networks.

In addition to integration of different communications networks and end user units, telecommunications web site TCW permits an individual communications control for each party. For instance, in case of two parties communicating via their respective telecommunications web site, each party can determine and change the set of end user units used (e.g., switching on/off of web cams for video conferencing, switching media chat to telephone, for example, etc.) without any break in communication. In particular, a party can decide to deny access to specific end user units (e.g., no faxes when calling a new business contact). This is in contrast to known Internet-based and telephone network-based communications environments, which provide for standardized interfaces and standardized communications functionalities, both of which offer a limited range of modification possibilities for different users.

Moreover, definitions, or settings, of telecommunications web site TCW may include defining how communications are to be routed to and/or from first end user unit EUU1 and/or specific entity SE. For example, specific entity SE may define via which gateway and/or which network communications will be executed to provide, e.g., for personal computer-based communications, telephone-based communications, etc. Thus, it can be defined that particular end user units are allowed to communicate with the owner of the telecommunications web site TCW, i.e., the specific entity SE, on the basis of a computer-computer-link only, while other end user units are also allowed to communicate to/or from telephones.

FIGS. 5a and 5b depict possible configurations for connections controlled by telecommunications web site TCW. In FIG. 5a, first end user unit EUU1 in PCTN network 52 desires to connect to a user using end user unit EUU2. The user of the first end user unit EUU1 calls telecommunications web site TCW via gateway G1 and connection means CM. Telecommunications web site TCW then initiates a connection to EUU2 via connection means CM and gateway G2 into UMTS network 54 in which EUU2 is situated. The connection is controlled by the telecommunications web site TCW through its control of connection means CM. In this case, connection means CM is an IP-switch controlling the connection established via gateway G1 to PSTN network 52 and gateway G2 into UMTS network 54. Thus, a connection between two completely different networks can be established via telecommunications web site TCW. As soon as the connection is terminated by the host of telecommunications web site TCW, connection means CM will terminate the connection between first end user unit EUU1 and EUU2. Thus, the host of telecommunications web site TCW, i.e., specific unit SE, is in control of the connection between first end user unit EUU1 and EUU2.

In FIG. 5b, a similar scenario to that in FIG. 5a is illustrated. In this case, first end user unit EUU1 seeks connection to end user unit EUU2, both being situated in the same kind of network, here PSTN network 55. First end user unit EUU1 contacts the telecommunications web site TCW. The telecommunications web site TCW establishes connection 56 via connection means CM, controlling switch SW to establish second connection 58 to the EUU2. These two connections to first end user unit EUU1 and to EUU2 are then connected by switch SW in PSTN network 55 to form a complete connection 59 between first end user unit EUU1 and EUU2. Switch SW is thus a PSTN-switch. The telecommunications web site TCW has control over the connection between first end user unit EUU1 and EUU2. If for instance the host of the telecommunications web site TCW, that is specific entity SE, accesses the telecommunications web site TCW (indicated by arrow A) specific entity SE may at the same time use end user unit EUU2, e.g., a telephone, for talking to the first end user unit EUU1 (indicated by arrow B). Thus, specific entity SE may control connection 59 using the telecommunications web site TCW, and communicate with first end user unit EUU1 using the telephone EUU2. To terminate connection 59, the specific entity may either terminate the connection by choosing so in the telecommunications web site TCW accessed for instance by a browser. The specific entity may also terminate connection 59 by hanging up the telephone EUU2. Further, the specific entity may choose to change the kind of end user unit he or she is using, i.e., EUU2, and connect via the telecommunications web site TCW to another end user unit and continue the communication with first end user unit EUU1.

FIG. 6 shows a schematic diagram in which participant A communicates with another participant, specific entity B, via telecommunications web site TCW using two different first end user units EUU1 and EUU2 at the same time in parallel. First end user unit EUU1 connects via the telecommunications web site TCW and connection means CM1 respectively, to end user unit SE-EUU1 of specific entity B. At the same time, the participant A may connect to participant B with end user unit EUU2 via the telecommunications web site TCW and connection means CM2, respectively, to end user unit SE-EUU2 associated with specific entity B. First end user unit EUU1 and end user unit SE-EUU1 may be TCP/IP video devices and monitors connected by connection means CM1, while EUU2 and SE-EUU2 may be PSTN devices, such as telephones, connected by connection means CM2. Connection means CM2 may be a PSTN-switch. With such an arrangement, multi-protocol chain 61 may be established with two different types of communication links, or channels 62 and 64. Here, communication link 62 is a video channel 62 and communication link 64 is a telephone channel. Participant A may be connected to specific entity B by telephone via a PSTN network. This connection, communication link 64, is controlled by the telecommunications web site TCW via connection means CM2. At the same time, the video picture is transmitted over communication link 62 via TCP/IP controlled by the telecommunications web site TCW via connection means CM1. Thus, participant A may speak to specific entity B without delays in the voice transmission via a PSTN network whereas the picture is transmitted via TCP/IP with an acceptable quality of service for video pictures. Both communication channels 62 and 64 are controlled by the same telecommunications web site TCW and may be routed according to costs, quality of service, or other parameters relevant for this kind of communication. In another embodiment, a third and/or a fourth channel may be established using additional types of communication links and end user units to communicate, for instance a fax machine, a UMTS device, a web page, etc.

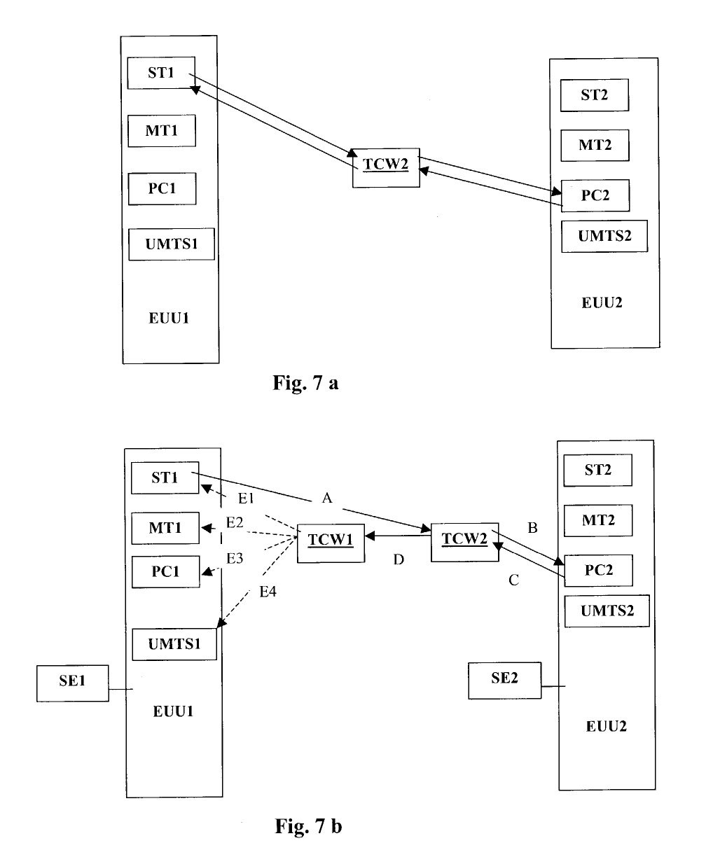

Referring now to FIGS. 7a and 7b, communication via one and two telecommunications web sites TCW, respectively, is illustrated.

In FIG. 7a, first end user unit EUU1 including any of an array of end devices, as well as end user unit EUU2 including any of an array of end devices, is illustrated. First end user unit EUU1 may be any of the following end devices: stationary telephone ST1, mobile telephone MT1, personal computer PC1 and UMTS device UMTS1. EUU2 may be any of the following end devices: stationary telephone ST2, mobile telephone MT2, personal computer PC2 and UMTS device UMTS2. A participant using first end user unit EUU1 calls telecommunications web site TCW2 with stationary telephone ST1. Telecommunications web site TCW2 recognizes a request to be connected to EUU2. Thus, after checking its stored user profiles, telecommunications web site TCW2 establishes the connection to personal computer PC2. Personal computer PC2 responds via the telecommunications web site TCW to stationary telephone ST1. In this example, the owner/host of telecommunications web site TCW2 has chosen personal computer PC2 as his preferred communications device for this specific date, time and/or accessing party. Personal computer PC2 uses a headset, soundcard and client software of telecommunications web site TCW2 to “talk” to a voice-over-IP gateway (not shown) of the telecommunications web site, which in turn allows the connection to the PSTN (not shown) used by stationary telephone ST1. In another embodiment telecommunications web site TCW2 could act as a speech-to-text and text-to-speech gateway, thus performing a “chat” function for the owner of the telecommunications web site and effecting a telephone call to the calling party. Such capability could be useful, for example, where the owner of telecommunications web site TCW2 is mute or deaf or unable to speak freely.

In FIG. 7b, a participant using first end user unit EUU1 uses stationary telephone ST1. In step A, stationary telephone ST1 contacts the second telecommunications web site TCW2. Second telecommunications web site TCW2 is associated with specific entity SE2, which uses second end user unit EUU2. The second telecommunications web site TCW2 recognizes a request to contact the user of EUU2 and connects in step B first end user unit EUU1 to personal computer PC2, in accordance with predetermined preferences of specific entity SE2. In response, PC2 contacts second telecommunications web site TCW2 in step C. Second telecommunications web site TCW2 now contacts first telecommunications web site TCW1 in step D. First telecommunications web site TCW1 is associated with specific entity SE1, which uses first end user unit EUU1. Since both telecommunications web sites TCW1 and TCW2 use the same protocol, first telecommunications web site TCW1 shares with second telecommunications web site TCW2 information as to which end devices of first end user unit EUU1 are available. Thus, the connection may now be established to stationary telephone ST1 according to step E1, to mobile telephone MT1 according to step E2, to personal computer PC1 according to step E3, or to UMTS1 according to step E4. The end device availability information is available because telecommunications web site TCW1 and telecommunications web site TCW2 share information regarding their respective associated end user units with each other. Thus, using the present invention, different end user units on each side of the communication may be integrated in a communication event.

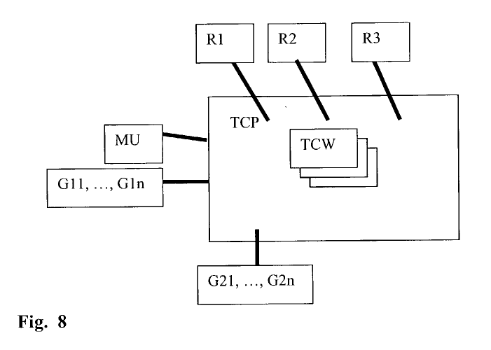

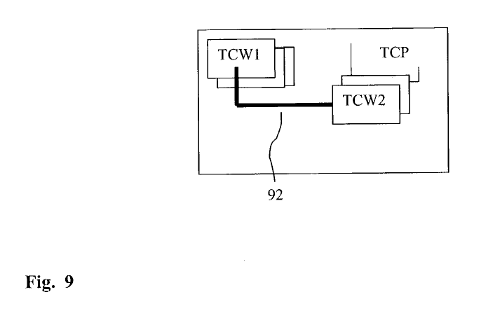

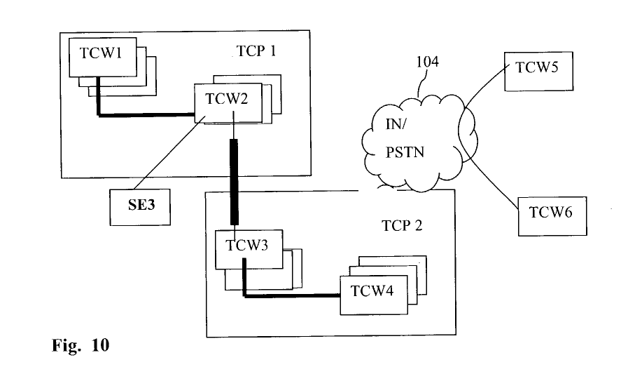

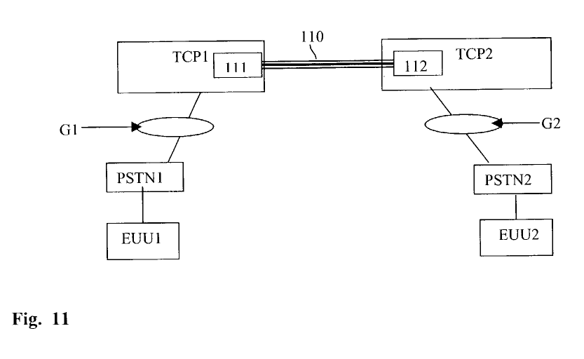

Referring now to FIG. 8, for providing telecommunications web site TCW, telecommunications portal TCP may be provided. Telecommunications web site TCW may have first end user unit EUU1 (not shown) and specific entity SE (not shown) associated with it. One or more telecommunications web sites TCW1 . . . TCWn may be provided on telecommunications portal TCP, each telecommunications web site having a respective associated end user unit and specific entity. Telecommunications portal TCP serves as a physical location, such as one or more servers, for example, whereon telecommunications web site TCW resides. This allows for an enhanced communications rate since data/information to be communicated are not required to be transmitted between separated or remote locations. Rather, all communications are exchanged through the telecommunications web site TCW, as if passing through a window, as discussed above. Further, telecommunications portal TCP is capable of providing telecommunications web site TCW in a manner compatible to first end user unit EUU1 and specific entity SE. In addition, the telecommunications portal TCP can control the compliance with definitions of telecommunications web site TCW, e.g., on the basis of memory unit MU associated with telecommunications portal TCP and telecommunications web site TCW, respectively. The definitions of telecommunications web site TCW may include individual user settings dependent upon available end user units, the available features of telecommunications web site TCW, etc. Moreover, telecommunications portal TCP is capable of communicating with gateways G11, . . . , G1n and G21, . . . , G2n to route communications links to first end user unit EUU1 and specific entity SE according to types and/or respective definitions for telecommunications web site TCW. Memory unit MU and gateways G11, . . . , G1n and G21, . . . , G2n may be referred to as resources of telecommunications portal TCP.

Further, telecommunications portal TCP may have various other different resources R1, R2 and R3 associated thereto. For example, resource R1 is a content managing system in which news contents, calendar functions, entertainment services and other content services of telecommunications portal TCP are provided. Resource R2 is a special high-speed gateway to the PSTN. Resource R3 is an optical fiber connection to three other telecommunications portals (not shown). Other types of resources may be provided. Thus, telecommunication web site TCW may use all resources R1 to R3, the memory unit MU and the gateways 1 and 2 provided by the telecommunications portal. In addition, other telecommunication web sites residing on telecommunications portal TCP may use these resources. All telecommunication web sites of telecommunications portal TCP may reside on the same server. Thus, communication between these telecommunication web sites on telecommunications portal TCP can be very fast and enhanced since the speed of communication between these web sites and the speed with which data exchange can take place may be very high. MP3 data files, picture files, text files and other data may be exchanged very quickly between the specific entities of the different on telecommunications portal TCP. As noted above, telecommunication web sites residing on telecommunications portal TCP may have an integrated consistent addressing scheme. Further, the telecommunication web sites on may communicate with a common protocol. Thus, the telecommunication web sites may automatically share certain information regarding the specific entities of these telecommunication web sites. New data entries of the specific entity in its telecommunication web site are exchanged automatically. For instance, the new address of a specific entity amended in its own telecommunication web site may be communicated to other telecommunication web sites in this telecommunications portal on accessing these web sites. Thus, communication between the telecommunication web sites of the same telecommunications portal TCP is enhanced.

In FIG. 9, communication between two telecommunication web sites TCW1 and TCW2 on the same telecommunications portal TCP is depicted. On telecommunications portal TCP, first telecommunication web site TCW1 is connected to second telecommunications web site TCW2 by communication link 92. In this case, communication link 92 is an optical fiber. Thus, first telecommunications web site TCW1 may communicate with second telecommunications web site TCW2 much faster than two other telecommunication web sites not residing on the same telecommunications portal. Such non-coresident telecommunication web sites may communicate via the Internet or a PSTN network, likely at a slower data rate. Thus, first telecommunications web site TCW1 and second telecommunications web site TCW2 residing on the same telecommunications portal TCP may communicate in an enhanced fashion.

In some embodiments, the same hardware and/or software components form both TCW1 and TCW2. Thus communication between the two may be accomplished by copying data within the same system of hardware. In other embodiments, the two telecommunications web sites are formed by at least some different hardware components located in close proximity to each other, for example in a common data processing center. In such embodiments, different hardware components may be linked by fast connections, such as a fiber optic connection, as discussed above, or other types of fast connections. Very fast communications with huge bandwidth between telecommunication web sites on different hardware may thereby be provided.

FIG. 10 shows two telecommunications portals TCP1 and TCP2. Telecommunication portal TCP1 has telecommunication web sites TCW1 and TCW2 resident thereon. Telecommunication portal TCP2 has telecommunication web sites TCW3 and TCW4 resident thereon. Telecommunications portals TCP1 and TCP2 are connected by high-speed link 102. Telecommunications portal TCP1 includes connection device 111 and telecommunications portal TCP2 includes connection device 112 for establishing high-speed link 102. Connection devices 111 and 112 may each be a converter, an adapter, an IP-switch, an ATM-switch, a mechanical or electromechanical switching board, a protocol translator, a gateway, a telephone network gateway, a UMTS/G3 network gateway, a computer network gateway, a television network gateway, a cable network gateway, an Internet gateway; a web server/client communicating via http, or a server/client communicating via a dedicated protocol, for example. High-speed link 102 enables telecommunications portal TCP1 and telecommunications portal TCP2 to communicate in a privileged and fast way. Telecommunications portal TCP1 and telecommunications portal TCP2 may control the quality of service of high-speed link 102. High-speed link 102 may be a dedicated link or reserved bandwidth on a shared link, for example.

Telecommunications portal TCP1 and telecommunications portal TCP2 use the same protocol chosen from a common list of protocols. This common protocol is used to exchange information regarding the telecommunication web sites residing on each of the telecommunications portal TCP1 and telecommunications portal TCP2. Thus, third telecommunications web site TCW3 knows automatically from data exchange between telecommunications portal TCP1 and telecommunications portal TCP2 necessary information regarding specific entity SE3 associated with third telecommunications web site TCW3. Third telecommunications web site TCW3 can connect to second telecommunications web site TCW2 using this information. Thus, not only communication between first telecommunications web site TCW1 and third telecommunications web site TCW3, residing on the same telecommunications portal, is privileged. Additionally, communication between third telecommunication web site TCW3 and second telecommunications web site TCW2 is privileged since they are both supported by the common protocols used by the telecommunications portal TCP1 and telecommunications portal TCP2. These protocols may be any of a variety of network protocols, such as https, http, ftp, smtp, or any file transfer protocol as defined for peer-to-peer file transfer (e.g., Napster, Gnutella, Freenet, OpenFT, etc.), any protocol for remote procedure calls such as CORBA, SOAP, DCE (Distributed Computing Environment) RPC of the Open Software Foundation (OSF), ONC (Open Network Computing) RPC of Sun Microsystems, or any protocol based on sending of TCP/IP or of UDP packets, or of other types of packets. Preferable are versions of these protocols that provide secure communication in the sense that the packets of data sent are encrypted and signed for security and authenticity. The communication between third telecommunications web site TCW3 and second telecommunications web site TCW2 is thus more advanced, faster and more privileged than, for instance, communication between fifth telecommunication web site TCW5 and sixth telecommunications web site TCW6 via network 104. Network 104 may be the Internet (IN) or a PSTN network, as shown FIG. 10.

Referring now to FIG. 11, two telecommunications portals TCP1 and TCP2 are shown connected by link 110, which may be a high-speed link, such as a fiber optic link, for example. Telecommunications portals TCP1 and TCP2 each include a respective connection device 111 and 112 for interfacing with link 110. Connection devices 111 and 112 may be a converter, an adapter, an IP-switch, an ATM-switch, a mechanical or electromechanical switching board, a protocol translator, a gateway, a telephone network gateway, a UMTS/G3 network gateway, a computer network gateway, a television network gateway, a cable network gateway, an Internet gateway; a web server/client communicating via http, or a server/client communicating via a dedicated protocol. Both telecommunications portals TCP I and TCP2 communicate according to a common protocol. Link 110 allows for synchronous communication. This means that the communication may have no, or minimal, delay that would cause a human being to be irritated. Thus, a human being may be able to communicate by voice via link 110 between the telecommunication portal TCP1 and telecommunications portal TCP2 because there is no delay in the data, containing the voice information, transmitted from telecommunications portal TCP1 to telecommunications portal TCP2 and vice versa. As a result, first end user unit EUU1 in PSTN network PSTN1 may access telecommunications portal TCP1 via gateway G1 and request a connection to EUU2 within PSTN network PSTN2. PSTN network PSTN2 is connected to telecommunications portal TCP2 via gateway G2. Since both telecommunications portals TCP1 and TCP2 are connected to each other with high-speed link 110, the first end user unit EUU1 may now communicate with EUU2 in PSTN-network PSTN2 in a real time manner without significant delays in the transmittal of the voice. Telecommunications portal TCP1 may be provided on a first continent and telecommunications portal TCP2 may be provided on a different continent. Therefore, two users may be advantageously connected by their access to the telecommunications portals via the gateway. First end user unit EUU1 may contact telecommunications portal TCP1 initiating a local call via gateway G1. Similarly, EUU2 may use PSTN2 to access telecommunications portal TCP2 and initiate a call via gateway G2. Thus, users of local PSTN-networks may only pay for accessing a respective local telecommunications portal. However, these users do not have to pay for the connection between telecommunications portal TCP1 and telecommunications portal TCP2, i.e., high-speed link 110. Thus, users in PSTN-networks PSTN1 and PSTN2 may be connected from continent to continent with each having to pay only for their local calls. Thus, a cost effective communication with a high quality of service may be provided.

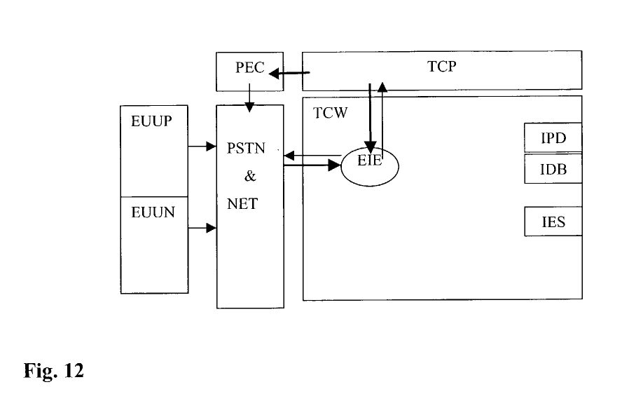

FIG. 12 shows telecommunications web site TCW having event identification element EIE. Further, telecommunications web site TCW may include individual protocol database IPD, individual database IDB and individual event settings element IES. In other embodiments, individual protocol database IPD, individual database IDB and individual event settings element IES may be not be integrated into telecommunications web site TCW, though the telecommunications web site may nevertheless be capable of accessing and modifying data stored in these databases. In individual protocol database IPD, protocol data of former connections handled by telecommunications web site TCW are provided and administered. Such protocol data may be historic data regarding connections with other parties, such as the date and the time of calls in the past, and archives in which former faxes, e-mails, notations and other types of communication data is stored. Individual protocol database IPD is adapted to provide all this information on former communications, connections or even data on the attempts to establish a connection. In individual database IDB, personal data of the host of telecommunications web site TCW is stored. Such personal data may be address information, definitions of groups grouping specific users or addresses, blacklists, telephone numbers, addresses, personal files, MP3 files, pictures, text files, video files, etc. Telecommunications web site TCW has access to this data of the individual database IDB. Further, individual events settings element IES comprises definitions and settings of the host of telecommunications web site TCW in which the host defines certain rules, filters, etc., to automate certain features and processes within telecommunications web site TCW. Such settings may be the information such as to which telephone number telecommunications web site TCW shall connect an incoming call or how to notify the host of telecommunications web site TCW in case of a certain person belonging to a predefined group is sending a fax, etc.

As shown in FIG. 12, telecommunications web site TCW is associated with telecommunications portal TCP. Telecommunications portal TCP may host a other telecommunications web sites (not shown in FIG. 12). Telecommunications portal TCP may provide special portal services from which the telecommunications web site TCW may benefit.

FIG. 12 shows public switched telephone network PSTN and network NET to which telecommunications web site TCW has access. Network NET may include an UMTS network, a PSTN network, a TCP/IP based network, an Internet-based network, a radio network, etc. Networks PSTN and NET may thus in some embodiments include the same PSTN network. End user units EUUP and EUUN have access to network PSTN and NET, respectively. End user unit EUUP may be a communication unit such as a telephone, a fax, an SMS device, a WAP device, an e-mail device, any of a variety of diverse telephone devices, a UMTS/3G device, etc. End user unit EUUP sends signals to network PSTN. End user unit EUUN sends signals to network NET, which may be a TCP/IP network or other appropriate network. For example, in an embodiment EUUN and EUUP may access the same PSTN network via an ISDN connection. In such an embodiment network PSTN and network NET include the same PSTN network at least from the ISDN connection to the next telephone switch. Beyond that switch, whether the networks are the same depends, for example, on the technology used by a relevant Internet provider. End user unit EUUN may be a UMTS/3G device, an e-mail device, any of a variety of diverse Internet devices, a device providing signals from news tickers or newsgroups, a device which indicates the presence of a user or a caller at a specific geographical location. End user unit EUUN may send alerts, receive alerts from another device or from network NET, send or receive signals in response to scheduled event, and send or receive voice over IP calls (VoIP calls). Telecommunications portal TCP may initiate via a portal event and call module PEC portal events and calls from the portal. Such portal events may be information on the status of other telecommunications web sites on the portal which are relevant to telecommunications web site TCW or information signals generated from events in databases of telecommunications portal TCP, such as services offered by telecommunications portal TCP, e.g., information on the stock market, a personal horoscope, news, the broadcasting of a specific program, etc. These events may be communicated to telecommunications web site TCW directly at event identification element or via portal event and calls module PEC and via network PSTN or NET to event identification element EIE.

From end user unit EUUP, e.g., a telephone, a call is initiated to telecommunications web site TCW. Thus, a signal from this telephone is sent to network PSTN. Network PSTN transfers this signal to telecommunications web site TCW. In telecommunications web site TCW, the signal is detected and recognized by event identification element EIE. Event identification element EIE identifies the signal as an incoming call from a telephone, end user unit EUUP. This information is transmitted to telecommunications web site TCW. Telecommunications web site TCW may now on the basis of settings within individual event settings element IES connect this call to a certain telephone number predefined by the host of telecommunications web site TCW for the case where a PSTN telephone end user unit calls. Thus, telecommunications web site TCW may decide to establish communication between telephone EUUP to a specific telephone (not shown in FIG. 12) of the host. This decision is made on the basis of settings of individual event settings element IES.

In another scenario, event identification element EIE may redirect all incoming calls to a specific telephone number of the host on default. Thus, all incoming calls are redirected to a specific number disregarding whatever settings are provided in individual event settings element IES. In another embodiment of the present invention, the host of telecommunications web site TCW may decide while the call is coming in that the host wants to take the call right away at a different telephone. In this case, the host may overrule the predefined event that is to be initiated by telecommunications web site TCW based on the identification of the event by event identification element EIE.

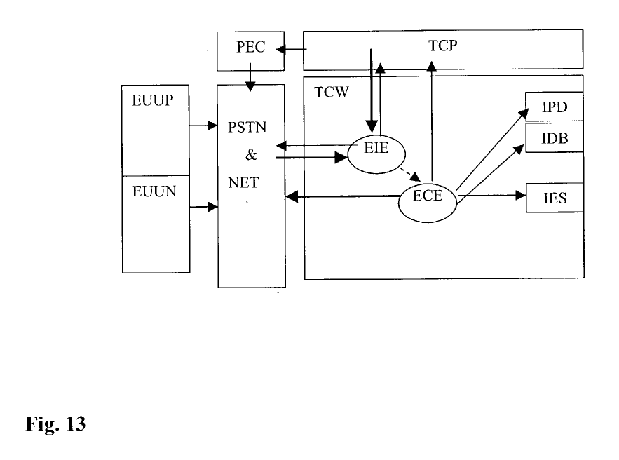

FIG. 13 shows telecommunications web site TCW having event identification element EIE and event creation element ECE.

FIG. 13 includes elements shown in FIG. 12, and additionally shows event creation element ECE. Event creation element ECE is adapted to create an event outgoing to network PSTN and/or network NET or to telecommunications portal TCP. Further, event creation element ECE may generate events that are transmitted to individual protocol database IPD, individual database IDB or individual event settings element IES. Event creation element ECE may receive signals from event identification element EIE so as to create an event dependent on an incoming event or another event identified by the event identification element EIE.

For example, event creation element ECE may receive a signal from event identification element EIE indicating that a telephone call is received. Event creation element ECE may then create an event modifying a layout of a web page of telecommunications web site TCW indicating to the host of the telecommunications web site TCW, for instance by a blinking button, that a telephone call is waiting. Further, event creation element ECE may create a second event modifying the layout of a web page presented to the caller showing a welcome layout with predefined content. Further, an event may be created based on which an entry in individual protocol database IPD is added and another event which may cause individual database IDB to produce data associated with the calling party. This information may be displayed to the host of telecommunications web site TCW. Event creation element ECE may also generate an SMS message to be sent to a predefined telecommunications device indicating that the call has been received. Another event may be created to modify the web page presented to the caller, inviting the caller to update certain data such as telephone books, entries into private databases, files, especially MP3 files, etc. These events may also be dependent on other internal criteria like date and time, special configurations of the telecommunication portal, etc. Thus, it is possible to create clusters of events dependent on criteria from event identification element EIE, telecommunications portal TCP, individual protocol database IPD, individual database IDB and/or individual event settings element IES.

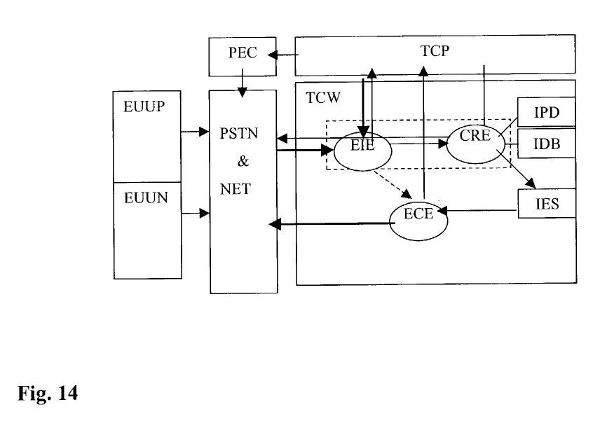

FIG. 14 shows telecommunications web site TCW having event identification element EIE, event creation element ECE and caller recognition element CRE.

FIG. 14 includes elements shown in FIG. 13, and additionally shows caller recognition element CRE. Caller recognition element CRE is connected to event identification element EIE, individual protocol database IPD, individual database IDB and individual event settings element IES. Caller recognition element CRE is connected to event creation element ECE via individual event settings element IES. Further, caller recognition element CRE is connected to telecommunications portal TCP.

Caller recognition element CRE may determine the identification of a calling party. Whereas event identification element EIE identifies an event, caller recognition element CRE recognizes the person behind the incoming event. Caller recognition element CRE may use a variety of types of data to recognize and identify the calling party. Caller recognition element CRE uses data transferred from the event identification element EIE. If this data contains the sufficient information to identify the calling party, caller recognition element CRE immediately renders a result. For instance, if the calling party is using a telephone via the ISDN protocol and transmits the telephone number, the caller recognition element may immediately know the telephone number of the calling party. With a search in individual database IDB, the name and address of the person behind that telephone number is retrieved and the calling party is identified with a high probability. In a situation where event identification element EIE cannot render sufficient information to identify the person behind the incoming event, caller recognition element CRE will gather more information to identify the calling party. For instance, a call via the Internet does usually not use fixed TCP/IP addresses. Thus, the incoming call cannot be identified by using solely the TCP/-IP address. In such cases, caller recognition element CRE will try to add more information by checking the configuration of the computer used for the incoming call. The configuration of processor type, RAM configuration, software version used, etc., then is compared to individual database IDB and individual protocol database IPD entries to identify persons that used a computer of this configuration in the past. Further, the date and time of the call may be matched to the calling behavior of persons from whom calls are stored in individual protocol database IPD. Using such measures, the probability of establishing the identity of a calling party behind an incoming event may be increased. Caller recognition element may choose to display a window to the calling party prompting the calling party to input a keyword or a password. Thus, caller recognition element CRE may fully identify the person calling telecommunications web site TCW.

Caller recognition element CRE and event identification element EIE may be integrated into one hardware and software module.

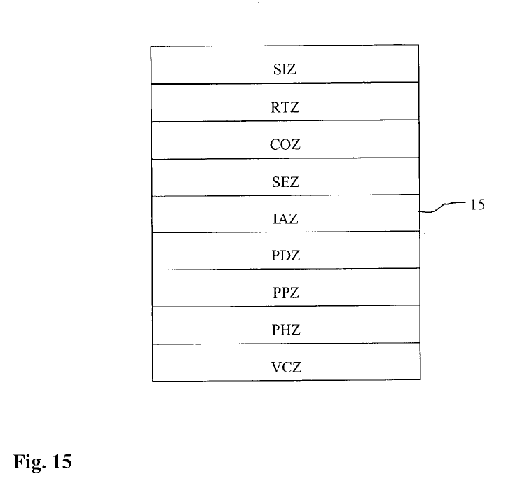

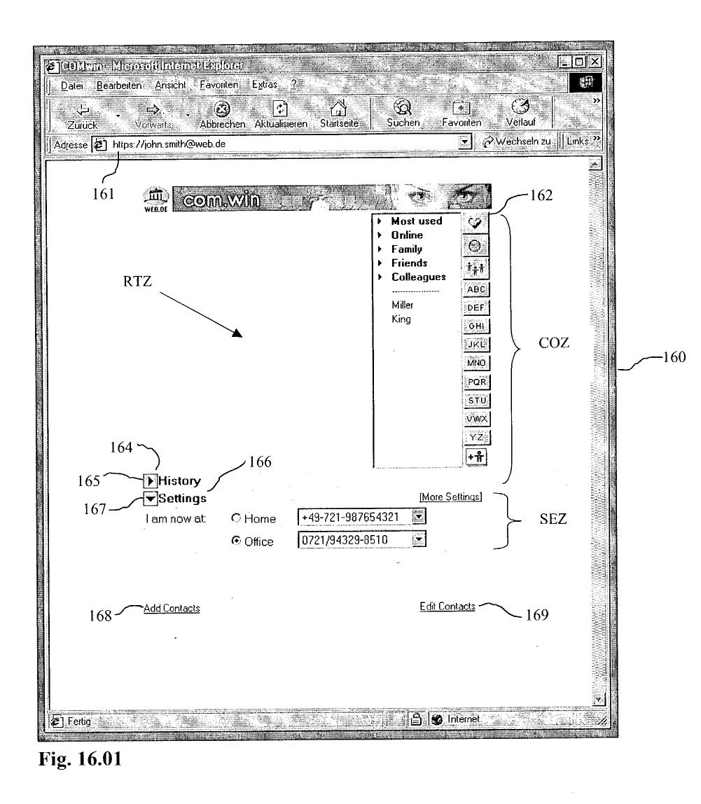

FIG. 15 shows a layout 15 of a web page of a telecommunications web site. Layout 15 has various zones, signaling zone SIZ, real-time zone RTZ, controlling zone COZ, settings zone SEZ, interactive zone IAZ, personal data zone PDZ, personal portal zone PPZ, personal home page zone PHZ, and video conferencing zone VCZ, in which different content and different functionality can be provided and displayed.

The display and arrangement of the different zones may be adaptable to the medium with which the zones are to be displayed. For instance, the zones may be arranged for easy use on a 640×480 screen of a personal computer or on a screen of the UMTS device.

In signaling zone SIZ, the status of a connection is displayed.

In real-time zone RTZ, the present user to be contacted may be displayed.

In controlling zone COZ, several buttons may be provided to choose addresses or persons to be contacted.

Settings zone SEZ may give the user the opportunity to define certain rules applicable to certain situations.

In interactive zone IAZ, an area may be provided in which a bi-directional real-time communication can take place. Users of the telecommunications web site or the calling party may interact with each other using interactive zone IAZ. In this interactive zone, drawing, writing, uploading and downloading of files may take place. These events may be instantaneously witnessed by the other party of the communication.

In personal data zone PDZ, personal files may be provided, especially for the host of the telecommunications web site.

Further, personal portal zone PPZ may be provided in which services of the portal are displayed and used by the host of the telecommunications web site. This area may be displayed to the calling party and/or the host of the telecommunications web site. The content may vary depending on the calling party. Thus, the horoscope of the calling party may be displayed when the telecommunications web site retrieves the party's date of birth from a retrieval database. In personal portal zone PPZ a different content may be displayed to the host of the telecommunications web site who, for instance, wants to be informed about the stock market performance of certain shares in his portfolio.

In personal home page zone PHZ, links to the personal home pages of the different persons, especially the host of the telecommunications web site, may be provided. Further, content of this personal home page zone might be provided directly.

In video conferencing zone VCZ, functionality to set up and take part in a videoconference may be provided. Several areas may be provided in which the other partners of this videoconference may be displayed. The person currently speaking may be highlighted, and the picture of this person displayed may be enlarged. Thus, the capability to easily follow the videoconference even with more than two participants may be provided.

The various zones of layout 15 described above are areas of the same semantic context so as to group functionality in a meaningful way for a human being. The zones may be formed using any of a variety of tools (for example, HTML, D-HTML, X-HTML, Javascript, JAVA-Applets) or programming languages (for example, JAVA, C++, TCL/TK, Python) or any other tools or advanced programming language suitable for achieving the desired screen layout and functionality, content provision and rendering, etc. The particular implementation of the zones depends on the platform and the device used. For a personal computer the implementation could be a browser with any combination of, e.g., HTML code, Active-X components, JavaScript and/or a Java Applet. For a mobile phone or PDA it might be, e.g., Java2 Micro Edition or Windows CE. For other communication devices it will be any language provided to develop applications for these devices.

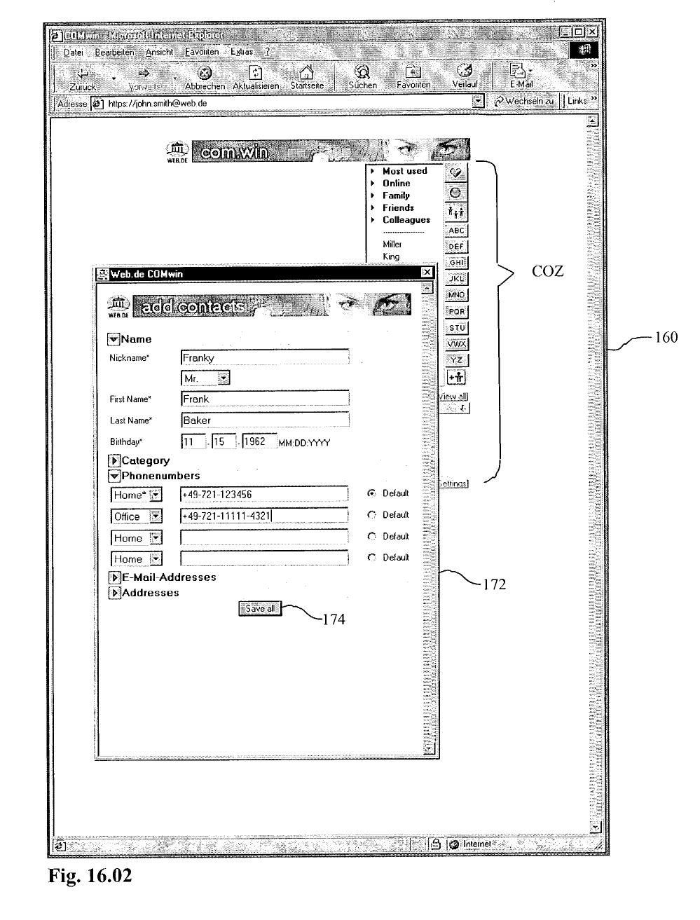

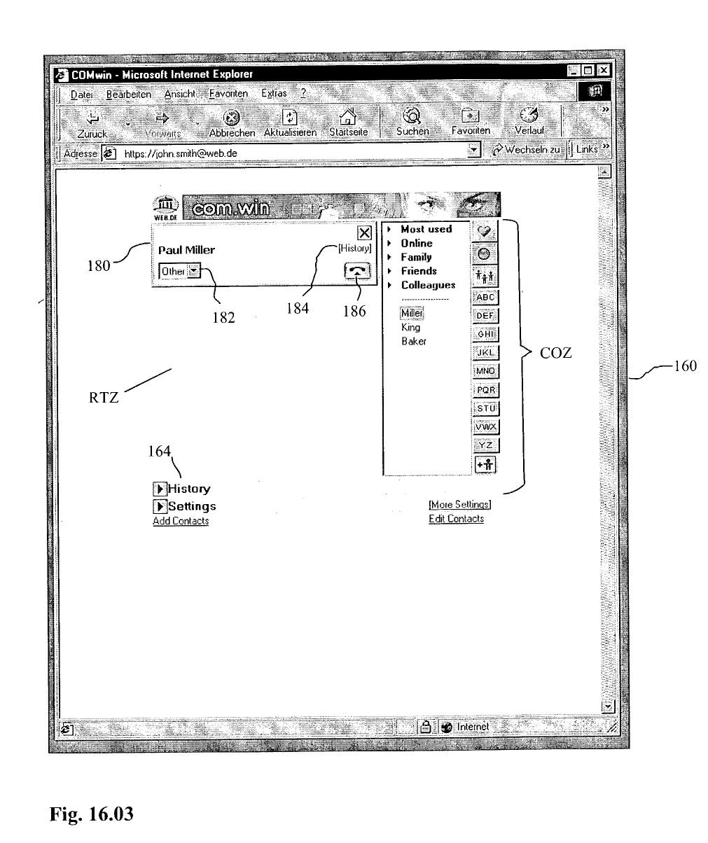

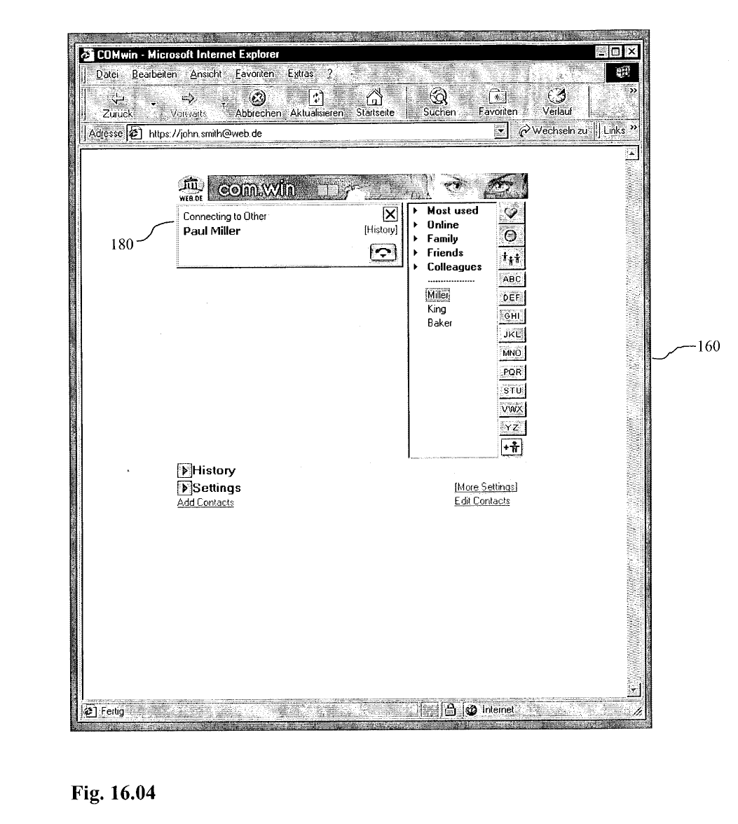

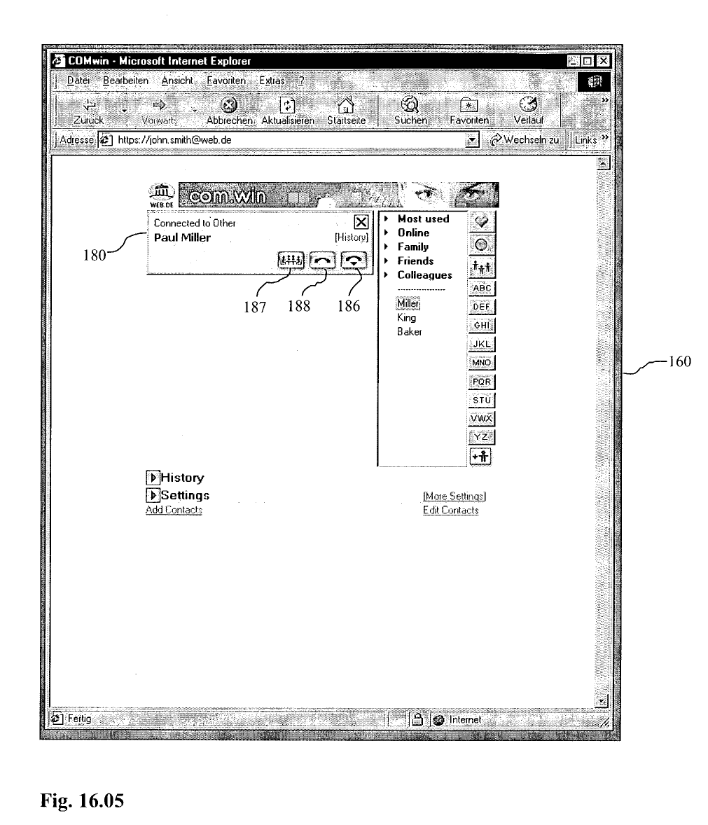

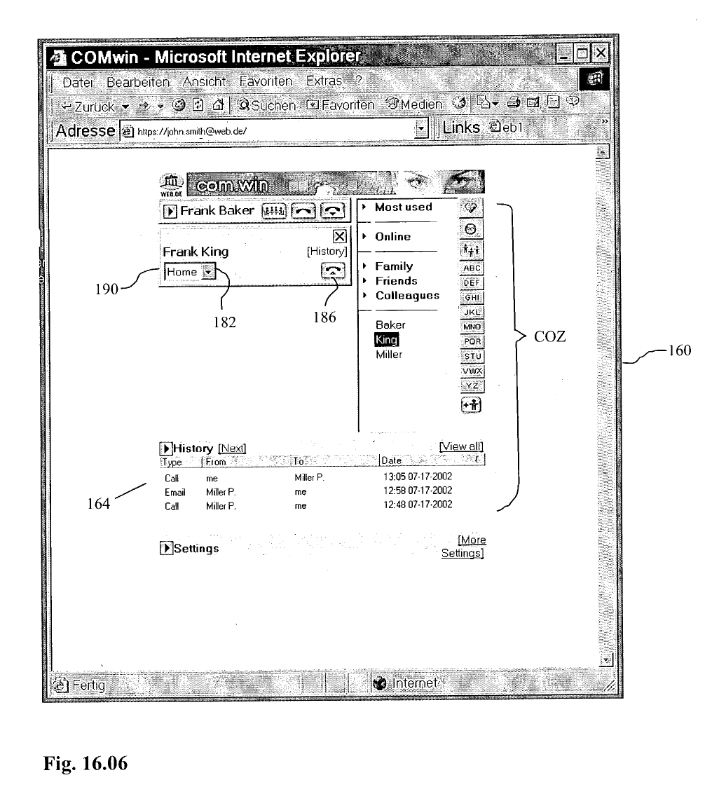

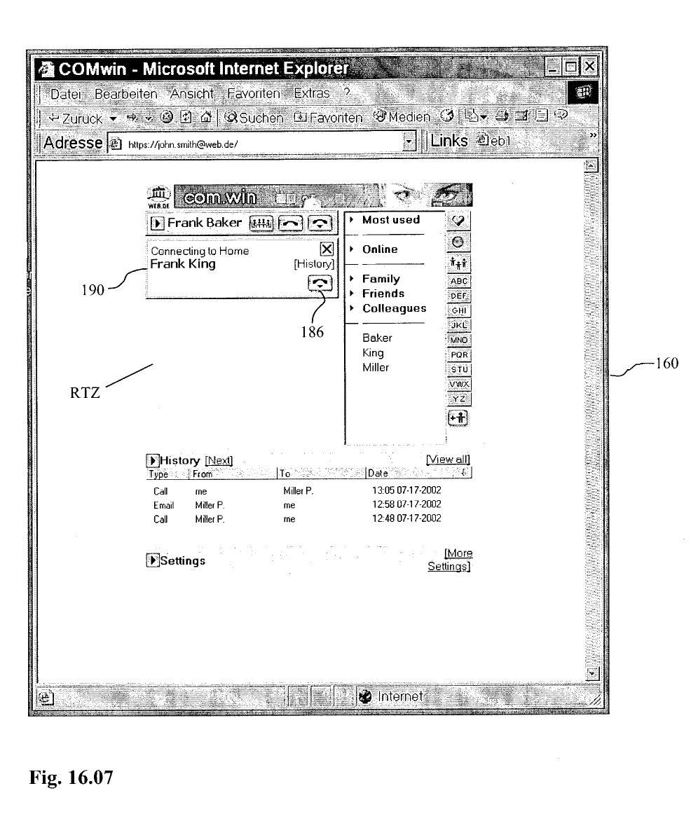

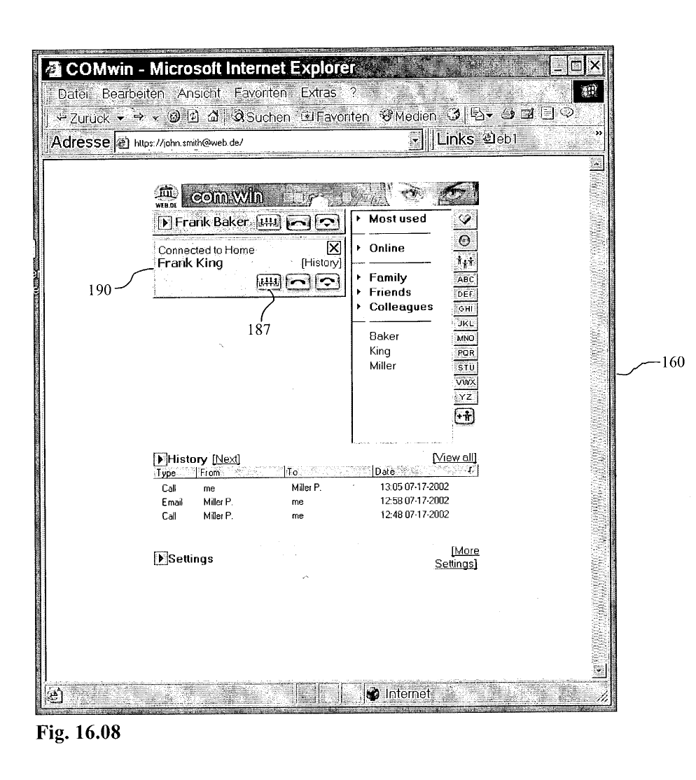

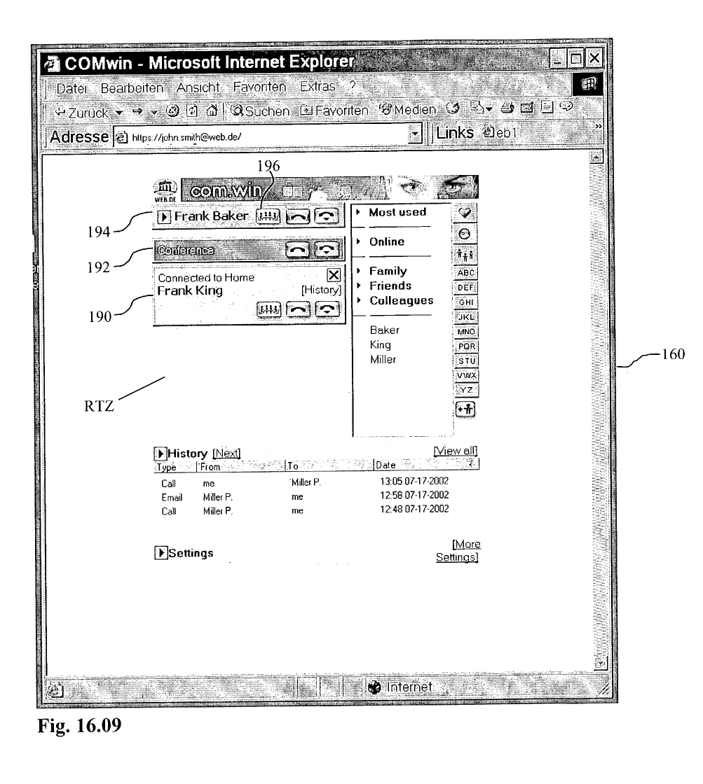

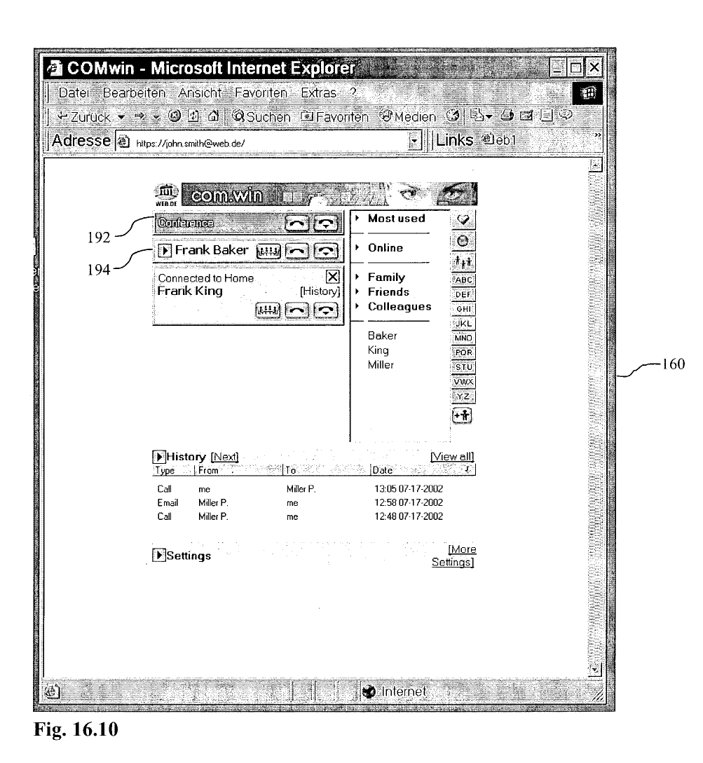

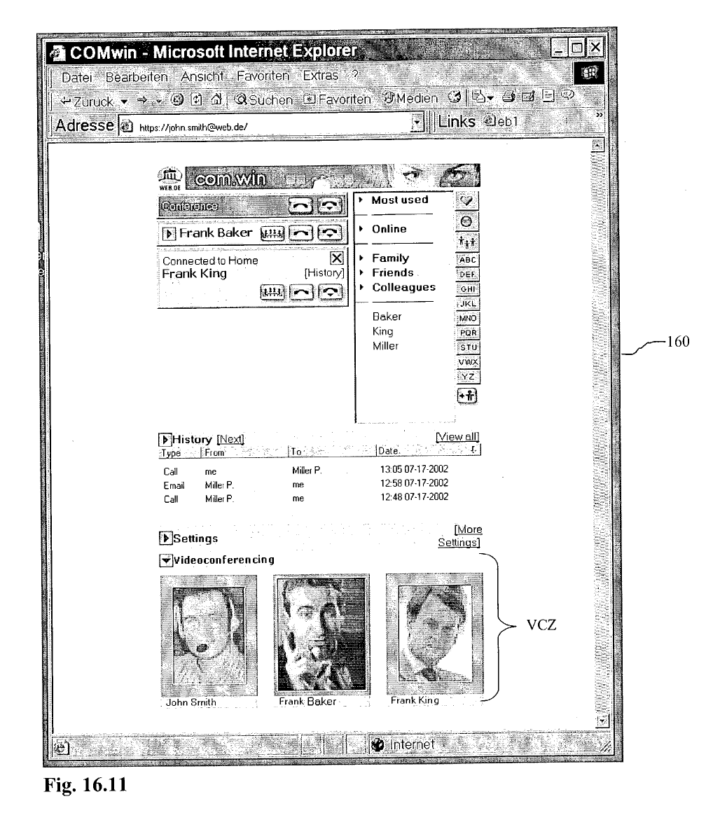

FIGS. 16.01 to 16.11 show screen shots of display layout 160 of a web page of a telecommunications web site in various respective states. The zone layout of layout 160 includes real-time zone RTZ, controlling zone COZ and settings zone SEZ. Layout 160 is displayed using browser-like software. The end user or host of the telecommunications web site is John Smith. The unique address of John Smith is https://john.smith web.de, displayed in “Adresse” (address) area 161.

In real-time zone RTZ, several sub-zones are displayed (see, e.g., FIGS. 16.09-16.11). In FIG. 16.01, real time zone RTZ is empty—no external call is received, no person is to be contacted.

In controlling zone COZ, sub-zones 162 and 164 are displayed. Sub-zone 162 displayed on the right side and includes a contact list. Further, the history is displayed. History sub-zone 164 is displayed in an abbreviated way at the far left side. Thus, only the title of sub-zone 164 is displayed. Sub-zone 164 includes a button 165 having an arrow. The button 165 allows the user to see a detailed list of the history.

Settings sub-zone 166 of settings zone SEZ includes button 167 having an arrow for displaying a list of telephone members the user may choose to indicate from where he is reachable at the moment. With these settings, the user may instruct the telecommunications web site to redirect incoming calls to the preselected telephone numbers.

In FIG. 16.01, the host John Smith has accessed his telecommunications web site using browser-like software. Real time zone RTZ is empty, since John Smith is not presently connected to another party. In controlling zone COZ, two names are displayed: “Miller” and “King”. In settings zone SEZ, the number of the office “0721/943298510” is preselected. At the bottom of the page, two buttons with specific functions are provided: “Add Contacts” button 168 and “Edit contacts” button 169. With these buttons, it is possible to either add a new contact or person to controlling zone COZ or to edit an already existing entry within the controlling zone.

John Smith now chooses to add a new contact and clicks on (activates) “Add Contacts” button 168 with his mouse.

The result is displayed in FIG. 16.02. A new window 172 has opened with a layout that is adapted to allow for inputting the necessary data to define a specific person to be added to the contact list. John Smith has typed the data into this layout using a keyboard connected to the computer on which the browser-like software is running. John Smith confirms the entry by clicking on “Save all” button 174. Thus, a new entry is added to controlling zone COZ of the telecommunications web site. Further, John Smith actuates button 167 in settings sub-zone 166 and closes sub-zone 166 (see FIG. 16.01). Then, John Smith selects the Name “Miller” in controlling zone COz.

The result is displayed in FIG. 16.03. In real time zone RTZ, information on Paul Miller is displayed, since “Miller” was selected in controlling zone COZ. Button 182 is provided with which a pull-down menu may be activated. Via this pull-down menu, John Smith may choose a telephone number to reach Paul Miller different from the default number. Further, history button 184 is provided. Activating button 184, John Smith may display all former contacts to “Paul Miller” in history sub-zone 164. In addition, button 186 is provided having a pictogram of a receiver and an upwardly directed arrow. Behind this arrow is the functionality to establish a connection between the chosen office telephone number of John Smith (“0721/943298510”) and the pre-selected telephone number of Paul Miller. John Smith activates button 186.

The result is illustrated in FIG. 16.04. Above the name “Paul Miller” in sub-zone 180, the status of the connection to be established is displayed: “Connecting to Other”. Thus, the telecommunications web site establishes a call in a PSTN-network between both parties from telephone to telephone. It was not necessary for either of the parties in the call to be established to touch his respective end user unit, i.e., telephone. The call is initiated by the telecommunications web site. The telephone of John Smith on his desk with the telephone number “0721/943298510” rings. John Smith picks up the telephone and is connected to Paul Miller.

The resulting display of the web page of the telecommunications web site is shown in FIG. 16.05. In sub-zone 180 the status “Connected to Other” is shown. Two more buttons are now displayed: conference button 187 with a pictogram of people sitting at a meeting table, and button 188, with a pictogram of a receiver without an arrow. Button 186 has changed to show a pictogram with the receiver and a downwardly directed arrow. Activating button 186 would terminate the connection between John Smith and Paul Miller. John Smith chooses to push this button and to end the communication.

Another communication scenario is illustrated in FIGS. 16.06 to 16.11. In FIG. 16.06, John Smith is connected with Frank Baker, talking to Frank Baker on the telephone. In controlling zone COZ, history sub-zone 164 is displayed in a detailed manner. In history sub-zone 164 the former calls between Paul Miller and John Smith are listed. Further, John Smith has chosen “King” as an address in controlling zone COZ. Thus, “Frank King” is displayed in sub-zone 190 of real time zone RTZ with the known details. John Smith activates button 186, with the pictogram of the receiver and the upwardly directed arrow. Thus, a connection is initiated to Frank King.

The result is shown in FIG. 16.07. Sub-zone 190 for “Frank King”, in real time zone RTZ displays the status “Connecting to home”. The “Home” telephone number has been chosen by John Smith using button 182 to contact Frank King. The pictogram with the receiver and the arrow on button 186 now displays an downwardly directed arrow. The functionality behind button 186 has changed and is now adapted to terminate the connection between John Smith and Frank King upon request.

After a short while, John Smith is connected to Frank King. The result is shown in FIG. 16.08. Now, the status in sub-zone 190 “Frank King” shows “Connected to Home”. Now, John Smith chooses conference button 187 in sub-zone 190.

As a result, shown in FIG. 16.09, a new sub-zone, conference sub-zone 192 is displayed in real time zone RTZ. Sub-zone 192 is displayed between sub-zone 194 for Frank Baker (above) and sub-zone 190 Frank King (beneath). Only the parties displayed beneath conference sub-zone 192 are participants of this conference. Thus, the first step to establish a conference with John Smith, Frank King and another party has been taken. However, Frank Baker is (not yet) a participant of this conference.

Now, John Smith activates conference button 196 in sub-zone 194 for Frank Baker. The result is shown in FIG. 16.10. Sub-zone 194 for Frank Baker is now also displayed beneath conference sub-zone 192. Thus, Frank Baker is now also a participant of the conference with John Smith and Frank King.

In FIG. 16.11, video conferencing zone VCZ is displayed beneath the other zones. In video conferencing zone VCZ, pictures of all participants in a videoconference are displayed, here the host of the telecommunications web site, John Smith, as well as participant Frank Baker and participant Frank King. Frank Baker is speaking at the moment. The picture of Frank Baker is therefore highlighted, i.e., enlarged. Thus, it is easy to follow the videoconference since the participants can, for example, concentrate on the highlighted Frank Baker as the person contributing to the conference in this moment.

FIG. 17 shows the architecture of a communications environment 200 according to an embodiment of the present invention. Communications environment 200 includes telecommunications web site 250 and client 201, which communicate over matrix 203. Matrix 203 may be the Internet or an intranet, for example. Telephone 202 serves as an end user unit, communicating with telecommunications web site 250 over PSTN 204 to access phone subsystem 205. Telephone 202 may belong to the specific entity, i.e., the owner of telecommunications web site 250. Telephone 202 includes handset 261 which serves as an interface for user input and output, i.e., voice signals. Other telephones may serve as end user units for other called parties and/or users of telecommunications web site 250 and may likewise communicate over PSTN 204 and access phone subsystem 205. Network interface device 262 is also included in telephone 202 for interfacing with PSTN 204. In other embodiments of the present invention, other types of end user units which access telecommunications web site 250 over other types of networks or communications links may be provided.

Client 201 provides a user interface for a user accessing telecommunications web site 250. The user may be any authorized user of telecommunications web site 250, including the specific entity. In an embodiment client 201 resides on a computing device of a user. In other embodiments client 201 may reside on other types of user communications devices. Where the user computing device is personal computer, client 201 may be a browser with a combination of, e.g., HTML code, Active-X components, JavaScript and/or an Java Applet. In another embodiment, client 201 is a stand-alone application. Using Active-X, Java or a stand-alone application enables active signaling to the client. A browser is only able to support “pull”-functionality, while an application supporting “push” functionality like “signaling that there is an incoming call” needs to be active listening on a communication port. Where the user computing device is a mobile phone or PDA client 201 may be implemented using, e.g., Java2 Micro Edition or Windows CE. For other user communication devices client 201 may be implemented using any language provided to develop applications for these devices.

More than one client 201 may be provided, each one corresponding to a given user. Client 201 includes CWSP listener module 261, HTML control module 262, and graphical user interface (GUI) 263. GUI 263 may be a browser-based graphical user interface including action buttons for clicking to perform actions. CWSP listener module 261 is a module that signals events (e.g., incoming call, new e-mail message, new fax, new visitor, etc.) to client 201. In an embodiment, the novel client-server signaling protocol described in European Patent Application No. 02 020 448.3, European attorney docket number 31536.WEB.P100EP, entitled “Signaling Protocol,” and above incorporated by reference herein, is used for communication between CWSP listener module 261 and real time server 207 (described below) of telecommunications web site 250. This novel signaling protocol, which will herein after be referred to as “signaling protocol CWSP,” provides for encryption (TLS 1.0/SSL3.0) of datagrams with asymmetric handshake and symmetric session encryption, with no need for certificates from client 201. Signaling protocol CWSP provides for signaling of the following:

Login Handshake

Signaling of Line States with unique LINE-Ids, including ringing and hang-up

Initiate Line Actions, including call number and route incoming call to a number

Client State, including represent the general state of the application and signal the refresh of certain areas on the client

Keep-Alive

Logout

Time-Sync

Packet-Delay measurement to ensure fast data rate

Presence Information of contacts (Logon/Logoff/Break/. . . ).

HTML control module 262 controls specific areas of the user interface and loads HTML pages into any controlled area on request by CWSP listener module 261. HTML control module 262 communicates with web server 210 (described below) of telecommunications web site 250. In an embodiment, HTML control module 262 is Microsoft Internet Explorer. Alternatively, HTML control module may be any other browser instance, such as Netscape Navigator or any other implementation of a browser. To ensure privacy of the communications between HTML control module 262 and web server 210, HTML control module 262 uses the protocol Hypertext Transfer Protocol over TLS (HTTPS), which is described in E. Rescorla, Memo, Network Working Group, “HTTPS Over TLS”, The Internet Society, 2000, which is hereby incorporated by reference herein.

Telecommunications web site 250 may includes a variety of components: phone subsystem 205, user manager 206, real time server 207, user profile database 208, web server 210, connection manager 211, core engine 212, presence manager 213, account manager 217, contact manager 218, log manager 219, and session manager 224. Some or all of the components of telecommunications web site 250 may be software components running on any of a variety of operating systems, such as any flavor of UNIX (BSD, Solaris, HP-UX, etc.), Linux, any Microsoft operating system (DOS, Windows 95, 98, NT, XP, ME, etc.), and any real time operating system (e.g., QNX, RTOS, EUROS, etc.), for example. Some or all of the components of telecommunications web site 250 may run on any of a variety of known or future computer hardware (e.g., Intel, AMD, HP, Sun, Motorola, IBM . . . ). Some or all of the components of telecommunications web site 250 may be written in any of a variety of programming language, preferably any higher programming language such as C, Fortran, Basic, Pascal, Lisp, etc., or any higher object oriented programming language such as C++, Java, Python, etc., or any script language like Perl, PHP, etc., for example. Some or all of the components of telecommunications web site 250 may reside on the same hardware and may communicate via any suitable interprocess communication method provided by the operating system.

When any component of telecommunications web site 250 communicates with any other component, whether residing or not residing on the same hardware, the relevant components may use any of a variety of network communication protocols, such as, for example, CORBA, RPC, SOAP, RPC via SOAP, HTTP, FTP, etc. Communication between components of telecommunications web site 250 may be established via mounting of file systems and exchange of files. Some or all of the components of telecommunications web site 250 may exist in parallel multiple times so as to provide a scalable system for many, even several million users or more. In some embodiments of the present invention, several instances of the same component may be distributed on several different hardware devices. Hardware links between different hardware devices may be any of a variety of communications links, such as Ethernet, for example, or other network types, using any of a variety of interfaces, such as serial, parallel, etc.

Database components, such as user profile database 208, contact database 221 (discussed below), accounting database 220 (discussed below), log database 222 (discussed below), and user database 223 (discussed below), may be any of a variety of relational databases, such as ORACLE, mySQL, etc., or object oriented databases, such as ‘Fast Objects’, an OQL database, XML Databases like dbXML, Tamino, X-Hive/DB, etc.

Phone subsystem 205 incorporates one or more private branch exchanges (PBX) 209. PBX 209 may include, for example, the Net@tec Phone Subsystem with NMS hardware, made by Net@tec. In an embodiment, phone subsystem 205, using PBX 209, provides the following functionality:

Signaling of incoming calls

Signaling of Phone Events (e.g., Ringing, Hang-up, Connect)

Signaling of DTFM

Creation of new Line Handles

Connection of 2 or more Line Handles for conferencing

Forwarding of incoming calls

User manager 206 receives login and password information and returns the corresponding user identification number if the combination is correct. In an embodiment, user manager 206 is a CORBA service providing functions for checking combinations of login name and password for their correctness. Alternatively, user manager 206 may be a service of another suitable protocol. User manager 206 communicates with user database 223 to check the login and password information and to locate the correct user identification number. User database 223 stores central user data, such as login, password and address information, for each user.

Real time server 207 is in one embodiment a CORBA service and a CORBA client with a CWSP listener interface so as to be able to communicate with clients 201 via signaling protocol CWSP and with other components of telecommunications web site 250 described below. Alternatively, real time server 207 may be a service and a client of another suitable protocol. Real time server 207 may reside on any suitable server hardware running on any suitable operating system In an embodiment, real time server 207 performs the following functions:

Sends all signals representing the current state of the system via signaling protocol CWSP to client 201.

Uses session manager 224 to share a session with web server 210. This ensures that the right combination of information is sent from real time server 207 and web server 210 to client 201. This ensures that no other user is able to access data of any other user.

Uses user profile database 208 to check the authorization level of a user. This is required because different users may have different contracts enabling them to use a different set of features of telecommunications web site 250.

Uses connection manager 224 to keep track of the lines (connections between phone subsystem 205 and any telephone) and logins of a given user. At any time the connection manager will know which lines on which PBX 209 and which logons on which instances of real time server 207 belong to a given user.

Uses presence manager 213 to keep track of the presence condition of any user.

Signals events to core engine 212 (e.g., the “call telephone number 00497219432940 button” was pressed on client 201), and receives information about the current state of the system from the core engine.

User profile database 208 holds user profiles containing information about the subscriber contract type, the user's telephones, personal settings and personal rules, invoices, permissions and the personal state graphs that describe the behavior of the system at any given time.

Web server 210 provides all information displayed on client 201 which is not being transported by signaling protocol CWSP. In an embodiment, web server 210 is an Apache web server with the proper set of HTML pages and Scripting functionality for creating dynamic and personalized web pages using data retrieved from the other components via, e.g., IIOP (CORBA) or other suitable protocol. Alternatively, web server 210 may be an MS-IIS web server or any other suitable web server. In an embodiment, web server 210 provides the following functions:

Creates a Client Home Page with the personal greeting text, which is displayed using client 201.

Receives personal text messages from visitors of telecommunications web site 250 and organizes delivery of these messages to the owner of telecommunications web site 250, i.e., the specific entity.

Talks to user profile database 208 to display or to set the personal settings and personal texts.

Uses log manager 219 to create individual pages of personal log data. Log data is a record of all communication (incoming and outgoing) via telecommunications web site 250. Pages are subsets of this record (e.g., all emails, all communication to a specific contact) sorted by any criteria (date, subject, etc.)

Uses contact manger 216 to create individual lists of contacts and to store new contacts created on client 201.

Connection manager 211 enables the ability to get a connection between logons and current ongoing calls for a given user at a given time. In an embodiment, connection manager 211 is a CORBA service providing the functions described below. Alternatively, connection manager 211 may be a service of another suitable protocol. Connection manager 211 may reside on any of a variety of hardware, e.g., INTEL-based or AMD-based with any of a variety of operating systems, e.g., Linux or MS-Windows. For the user, or specific entity, there are several ways to get into contact with telecommunications web site 250. One of these ways is using client 201 on, e.g., a personal computer. To authorize his access, the specific entity types in his username and password and is then granted access to the telecommunications web site with certain privileges. This is called “logon”. The specific entity may be logged on from different systems at the same time. For an incoming telephone call to the specific entity's telecommunications web site phone number, core engine 212 can access from connection manager 211 which system and with which address(es) the specific entity is logged on. This capability is advantageous for visualizing, on client 201, the current state (logons, connection details, etc.) of telecommunications web site 250. In an embodiment, connection manager 211 provides the following functionality:

Holds accounts of all logons and the associated real time server(s). Depending on the size of telecommunications web site 250, more than one real time server may be provided. A logon may be associated with a particular real time server.

Holds accounts of all ongoing calls and associated core engine(s). Depending on the size of telecommunications web site 250, more than one core engine may be provided. An ongoing call may be associated with a particular core engine.

It provides functions to find all real time server sessions and all core engines belonging to a specific entity.

Core engine 212 is a central component of telecommunications web site 250, and controls the current states of the telecommunications web site, and includes state manager 214, state engine 215 and rule engine 216. In an embodiment, core engine 212 is a CORBA service and CORBA client providing the functions described below. Alternatively, core engine 212 may be a service and client of another suitable protocol. Core engine 212 may reside on any of a variety of hardware, e.g., INTEL-based or AMD-based with any of a variety of operating systems, e.g., Linux or MS-Windows. In an embodiment, core engine 212 provides the following functions:

Uses several state managers 214 to communicate with user manager 206, real time server 207, user profile database 208, PBX 209, connection manager 211, presence manager 213, account manager 217, contact manager 218, and log manager 219.

Uses real time server 207 to signal events and the current state of the system to client 201; receives events from real time server 207.

Uses user profile database 208 to authorize calls and to retrieve user profile data for, for example, call forwarding functionality, time based change of profiles, checking of permissions, etc.

Uses phone subsystem 205 to initiate calls and conferences; and receives signals from phone subsystem 205 about incoming calls, hang-ups, DTFMs, etc.

Uses connection manager 211 to store information about current calls and to determine the respective real time server 207 instance to signal the state of each current call to.

Uses presence manager 213 to store current presence information for each user.

Uses accounting manager 217 to write call data records for accounting.

Uses contact manager 218 to identify calling numbers as known contacts.

Depending on this identification the forwarding might be different. The specific entity can set profiles defining, for example, that a call from user A should always be forwarded to the secretary, while a call from user B should be forwarded to his mobile phone, if the call is within normal business hours. Thus, the reaction of telecommunications web site 250 can depend on the caller, etc.

Uses log manager 219 to write personal log records of calls.

Presence manager 213 is responsible for tracking the current presence status (offline, online, reachable, in break, in conference, etc.) of users. In an embodiment, presence manager 213 is a CORBA service providing the functions described below. Alternatively, presence manager 213 may be a service of another suitable protocol. Presence manager 213 may reside on any of a variety of hardware, e.g., INTEL-based or AMD-based with any of a variety of operating systems, e.g., Linux or MS-Windows. In an embodiment, presence manager 213 provides the following functionality:

Stores current presence information as set by real time server 207 and core engine 212.

Delivers the current presence information to real time server 207 and core engine 212.

State manager 214 of core engine 212 serves as the communicating part of core engine 212. State manager 214 is a subsystem of the core engine 212 and in an embodiment is a CORBA service providing the functions described below. Alternatively, state manager 214 may be a service of another suitable protocol. State manager 214 may reside on any of a variety of hardware, e.g., INTEL-based or AMD-based with any of a variety of operating systems, e.g., Linux or MS-Windows. In an embodiment of the present invention, state manager 214 may serve as a CORBA client and/or CORBA server for one or more of real time server 207, user profile database 208, PBX 209, connection manager 211, presence manager 213, account manager 217, contact manager 218, and log manager 219. In an embodiment, state manager 214 provides the following functionality:

Represents the current state of the system for real time server 207, user profile database 208, PBX 209, connection manager 211, presence manager 213, account manager 217, contact manager 218, and log manager 219.

Passes necessary information to state engine 215. For example, loads a user state graph from profile database 208 and passes the graph onto state engine 215.

Receives information from state engine 215 and initiates the appropriate calls of functions of real time server 207, user profile database 208, connection manager 211, presence manager 213, account manager 217, contact manager 218, and log manager 219.

State engine 215 uses the user state graph from user profile database 208 to move from one state to another; and executes the defined rules and triggers the appropriate actions, or events, via state manager 214. State engine 215 uses rule engine 216 to evaluate rules defined by the user, which are relevant to the current state. This evaluation process results in the next move by state engine 215 on the user state graph. State engine 215 thus provides a way to move on a user state graph and to control the behavior of telecommunications web site 250 according to the rules. In an embodiment, state engine 215 is software written in the C++ programming language. Alternatively, state engine 215 may be software written in any of a variety of other higher programming languages. State engine 215 may reside on any of a variety of hardware, e.g., INTEL-based or AMD-based with any of a variety of operating systems, e.g., Linux or MS-Windows.

Rule engine 216 provides evaluation of user defined rules stored in user profile database 208, including checking preconditions and deciding whether or not the rule must be applied. These rules provide actions associated with respective conditions. The specific entity can set profiles defining, for example, that a call from user A should always be forwarded to the secretary, while a call from user B should be forwarded to his mobile phone, if the call is within normal business hours. Thus, the reaction of telecommunications web site 250 can depend on the caller, etc. In an embodiment, rule engine 216 is software written in the C++ programming language. Alternatively, rule engine 216 may be software written in any of a variety of other higher programming languages. Rule engine 216 may reside on any of a variety of hardware, e.g., INTEL-based or AMD-based with any of a variety of operating systems, e.g., Linux or MS-Windows.

Accounting manager 217 receives accounting-relevant information, e.g., call data, records from state manager 214 which were created in state engine 215. In order to perform these tasks, accounting manager 217 provides an interface, e.g., CORBA, with functions to write and read accounting information. These call data records are then written into accounting database 220 for future processing, such as for billing purposes. In an embodiment, accounting manager 217 is software written in the C++ programming language. Alternatively, accounting manager 217 may be software written in any of a variety of other higher programming languages. Accounting manager 217 may reside on any of a variety of hardware, e.g., INTEL-based or AMD-based with any of a variety of operating systems, e.g., Linux or MS-Windows.

Contact manager 218 stores user contact data in contact database 221. User contact data may include, for example, title, first and last name, sex, date of birth, phone numbers, fax numbers, postal addresses, email addresses, etc. In an embodiment, contact manager 218 is a CORBA service that provides an interface with functions to store, retrieve, change and delete contact information. Alternatively, contact manager 218 may be a service of another suitable protocol. Contact manager 218 serves as an interface for storage and retrieval by web server 210, and retrieval by core engine 212, of contact data. In an embodiment, contact manager 218 is software written in the C++ programming language. Alternatively, contact manager 218 may be software written in any of a variety of other higher programming languages. Contact manager 218 may reside on any of a variety of hardware, e.g., INTEL-based or AMD-based with any of a variety of operating systems, e.g., Linux or MS-Windows.

Log manager 219 stores user log data in log database 222. User log data are records of communications of a given user, e.g.: “3.3.2002 17:01 Call from Frank—Duration 1:23”, “3.3.2002 17:15 Email to Frank—Size 69.345 Bytes”. In an embodiment, log manager 219 is a CORBA service that provides an interface with functions to store, retrieve, change and delete user log data. Alternatively, log manager 219 may be a service of another suitable protocol. In an embodiment, log manager 219 is software written in the C++ programming language. Alternatively, log manager 219 may be software written in any of a variety of other higher programming languages. Log manager 219 may reside on any of a variety of hardware, e.g., INTEL-based or AMD-based with any of a variety of operating systems, e.g., Linux or MS-Windows. In an embodiment, log manager 219 provides the following functionality:

Receives log data from core engine 212.

Answers requests for user log data from web server 210, returning the data in specifically filtered or sorted formats. An example of such a user log data request is a request for all calls from a special user within the last 2 months.

Allows certain requests from web server 210 to delete specific log data.

Allows certain requests from web server 210 to add documents to specific log data entries. Examples of such documents include a note about a given phone call, documents exchanged during a given phone call, etc.

Session manager 224 creates and stores a record of each user session. In an embodiment, session manager 224 is a CORBA service that provides an interface with functions to open, close and check a session. Alternatively, session manager 224 may be a service of another suitable protocol. In an embodiment, session manager 224 is software written in the C++ programming language. Alternatively, session manager 224 may be software written in any of a variety of other higher programming languages. Session manager 224 may reside on any of a variety of hardware, e.g., INTEL-based or AMD-based with any of a variety of operating systems, e.g., Linux or MS-Windows. In an embodiment, session manager 224 provides the following functionality:

Upon login via real time server 207 or via web server 210, creates a session and an associated unique session token. Since messages from client 201 to real time server 207 and web server 210 need a valid session token in order to be executed, real time server 207 and web server 210 check each request for the session token and request validation from session server 207.

Deletes a session after a defined time of inactivity.

It should be noted that telecommunications web site 250 is scaleable. Some or all of the above-described components may be duplicated several times, depending on the number of users and size of telecommunications web site 250.

In an embodiment, event identification element EIE (see FIGS. 12-14) includes core engine 212, which receives signals from PBX 209 and real time server 207 (which itself receives inputs from client 201) indicating different incoming events. The signals relate directly to these events. Event identification element EIE may include client 201 and PBX 209, which enable identification of simple events such as mouse clicks or telephone hook on actions. Evaluation of rules and complex scenarios is performed by core engine 212.

In an embodiment, event creation element ECE (see FIGS. 13-14) includes state engine 215 and rule engine 216 of core engine 212 for triggering outgoing events based on the rules.

In an embodiment, caller recognition element CRE (see FIG. 14) includes PBX 209, core engine 212 and web server 210. A caller accesses PBX 209 or web server 210. Information created in PBX 209 or web server 210 is processed by core engine 212 and/or web server 210 to identify the caller.

In an embodiment, individual event settings element IES (see FIGS. 12-14) includes web server 210, user profile database 208 and core engine 212. Web server 210 uses client 201 to display the current settings, which are stored in user profile database 208, while core engine 212 adjusts its reactions based on the settings in the user profile database.

In an embodiment, individual protocol database IPD (see FIGS. 12-14) includes log manager 219 and log database 222. Log database 222 is responsible for storing the protocol (records of communications) of a given user, while log manager 219 is responsible for caching requests by web server 210 and maintaining the connection to core engine 212 so as to keep control the load on log database 222.

In an embodiment, individual database IDB (see FIGS. 12-14) includes contact manager 218 and contact database 221, as well as user profile database 208. Contact manager 218 is responsible for caching requests by the web server 210 and maintaining the connection to the core engine 212 so as to control the load on the contact database 221.

The functioning of communications environment 200 will now be demonstrated by way of examples.

### EXAMPLE 1

FIGS. 2a and 17 may be used to demonstrate initiation of a call to a desired called party, say user 1 of end user unit EUU1, by specific entity SE, the owner of telecommunications web site 250 using client 201 to prompt the web site to establish respective connections between PBX 209 and each party over the PSTN. Here, telecommunications web site TCW and connections means CM in FIG. 2a correspond to telecommunications web site 250 and phone subsystem 205, respectively, in FIG. 17. Assumed initiate state of communications environment 200 is as follows: No ongoing calls; no precall (i.e., no call from an end user unit of specific entity SE to telecommunications web site 250 where the telecommunications web site does not yet know where to forward this call to. The specific entity might decide to choose a calling destination on client 201); specific entity SE is logged on to telecommunications web site 250 with client 201. The chain of events in communications environment 200 is as follows:

1. Specific entity SE first selects the desired called party, user 1 of end user unit EUU1, and clicks on a “connect” button (not shown) of client 201.

2. Client 201 sends a connect message via using CWSP Listener 261 via the CWSP protocol to real time server 207.

3. Real time server 207 sends an “event” to core engine 212. An event is any occurrence which might change the state of telecommunications web site 250, e.g., “specific entity SE just logged on”, “specific entity SE logged off”, “specific entity SE clicked on Button xyz on the client”, “specific entity SE wants to call #xx.xx.xx.xx”, etc.

4. Core engine 212 loads state engine 215 with the appropriate state graph and sends a signal “connect to phone number x (of specific entity SE)” to PBX 209.

5. PBX 209 connects over PSTN 204 to telephone 202 belonging to specific entity SE. The telephone rings.

6. Specific entity SE answers.

7. PBX 209 signals the successful connection to core engine 212.

8. Core engine 212 sends a signal “forward this call of specific entity SE to phone number y (of the user 1 to be called)” to PBX 209.

9. PBX 209 connects over PSTN 204 to end user unit EUU1, here the telephone of user I (not shown). The telephone rings.

10. User 1 answers his telephone.

11. PBX 209 sends a signal “connected number x to number y” to core engine 212.

12. Core engine 212 starts an internal call timer (not shown) to keep track of the call time.

13. The telephone call is carried on.

14. One of the parties (specific entity SE or user 1) hangs up.

15. PBX 209 receives a “hang up” signal from PSTN 204 and hangs up the connection to the other party.

16. PBX 209 signals the end of the call to core engine 212.

17. Core engine 212 stops the internal call timer, writes an appropriate log entry to the log manager 219 and a call data record to accounting manager 217.

18. Core engine 212 sends a signal “hang up” to real time server 207.

19. Real time server 207 sends a signal “hang up” via protocol CWSP to client 201.

### EXAMPLE 2

FIGS. 2b and 17 may be used to demonstrate initiation of a call user I of end user unit EUU1 by specific entity SE by calling in to telecommunications web site 250 using telephone 202. Again, telecommunications web site TCW and connections means CM in FIG. 2a correspond to telecommunications web site 250 and phone subsystem 205, respectively, in FIG. 17. Assumed initiate state of communications environment 200 is as follows: No ongoing calls; no precall; specific entity SE is logged on to with client 201. The chain of events in communications environment 200 is as follows:

1. Specific entity SE takes telephone 202 off hook and dials a personal assigned telephone number to telecommunications web site 250.

2. PBX 209 signals the incoming call from specific entity SE to core engine 212.

3. Core engine 212 loads state engine 212 with the appropriate state graph and waits for any signal.

4. Specific entity SE selects the desired called party, user I of end user unit EUU1, and clicks on a “connect” button (not shown) of client 201.

5. Client 201 sends a connect message using CWSP listener 261 via protocol CWSP to real time server 207.

6. Real time server 207 sends the event to core engine 212.

7. Core engine 212 sends a signal “forward this call of specific entity SE to phone number y (of user 1) to PBX 209. (actions now follow as in steps 9-19 of Example 1 above)

### EXAMPLE 3

FIGS. 2c and 17 may be used to demonstrate initiation of a call by user 1 of EUU1 by calling in to telecommunications web site 250 using end user unit EUU1, a telephone of user 1 (not shown). Again, telecommunications web site TCW and connections means CM in FIG. 2a correspond to telecommunications web site 250 and phone subsystem 205, respectively, in FIG. 17. Assumed initiate state of communications environment 200 is as follows: No ongoing calls; no precall.

1. User 1 dials the personal assigned phone number on telecommunications web site 250 of specific entity SE using end user unit EUU1.

2. PBX 209 signals the incoming call to core engine 212.

3. Core engine 212 loads state engine 215 with the appropriate state graph and uses rule engine 216 to evaluate the current rules. This evaluation yields the number of the current device on which specific entity SE is currently reachable.

4. Core engine 212 send a signal to “forward this call to the phone number x (of specific entity SE)” to PBX 209.

5. PBX 209 connects end user unit EUU1 to telephone 202 of specific entity SE.

6. The preferred telephone device (telephone 202) of specific entity SE rings.

7. Specific entity SE answers telephone. (actions now follow as in steps 11-19 of Example 1 above)

### EXAMPLE 4

FIGS. 2d and 17 may be used to demonstrate conference calling between specific entity SE, end user unit EUU1 and end user unit EUU2 of a second end user 2, as well as toggling by specific entity SE between end user units EUU1 and EUU2. Again, telecommunications web site TCW and connections means CM in FIG. 2a correspond to telecommunications web site 250 and phone subsystem 205, respectively, in FIG. 17. Assumed initiate state of communications environment 200 is as follows: an ongoing call between specific entity SE and end user unit EUU1 of user 1, which ongoing call may have been established as in Examples 1, 2 or 3 above.

1. User 2 dials the personal assigned phone number on telecommunications web site 250 of specific entity SE using end user unit EUU2.

2. PBX 209 signals the incoming call to core engine 212.

3. Core engine 212 sends a signal “incoming call from phone number z (of user 2)” to real time server 207.

4. Real time server 207 sends a signal “incoming call from phone number z (of user 2)” via protocol CWSP to CWSP listener of client 201.

5. Client 201 of specific entity SE indicates the incoming call.

6. Specific entity SE clicks on an appropriate button on GUI 263 of client 201 to toggle between the call with user I and the call with user 2.

7. Client 201 sends a signal “toggle calls” via CWSP listener using protocol CWSP to real time server 207.

8. Real time server 207 sends a signal “toggle calls” to core engine 212.

9. Core engine 212 sends a signal “put call from user 1 on hold” to PBX 209.

10. PBX 209 puts the call with user 1 on hold and signals the successful action to core engine 212.

11. Core engine 212 sends a signal “connect specific entity SE to EUU2” to PBX 209.

12. PBX 209 signals the successful connection to core engine 212.

13. Specific entity SE and user 2 talk together.

14. Specific entity SE decides to initiate a conference call with users 1 and 2. Specific entity SE clicks on an appropriate conference button on GUI 263 of client 201 for the “on hold” connection to user 1.

15. Client 201 signals “initiate conference” via CWSP listener 261 using protocol CWSP to real time server 207.

16. Real time server 207 signals “initiate conference” to core engine 212.

17. Core engine 212 signals “add connection to user 1 to the ongoing call between user 2 and specific entity SE” to PBX 209.

18. PBX 209 connects user 1, user 2 and specific entity SE and signals success to core engine 212.

19. User 1, user 2 and specific entity SE talk together in a conference.

20. Core engine 212 signals the successful conference to real time server 207.

21. Real time server 207 signals the conference to CWSP listener of client 201 via protocol CWSP.

22. Client 201 provides an indication of the conference on GUI 263.

23. Specific entity SE decides to finish the conference and clicks on a “hang up” button on GUI 263.

24. Client 201 signals “hang up” to real time server 207.

25. Real time server 207 signals “hang up” to core engine 212.

26. Core engine 212 signals “hang up” to PBX 209.

27. PBX 209 hangs up all 3 connections. (actions now follow as in steps 16-19 of Example 1 above)

### EXAMPLE 5

FIGS. 7b and 17 may be used to demonstrate the interaction between telecommunications web sites when the respective owners (specific entities) of the web sites communicate with each other. Telecommunications web site TCW1 corresponds to specific entity SE1, which uses end user unit EUU1, while telecommunications web site TCW2 corresponds to specific entity SE2, which uses end user unit EUU2.

Communications over connections A and B (FIG. 7b) may be established between end user unit EUU1 and end user unit EUU2 as in Example 3 above. Additionally, because the two web sites are connected to each other, telecommunications web site TCW2 recognizes the calling party, SE1, as the owner of telecommunications web site TCW1. Web server 210 of telecommunications web site TCW2 therefore connects as a client to web server 210 of telecommunications web site TCW1 and exchange user profiles and information about available end devices of end user unit EUU1. Telecommunications web site TCW1 may then establish a second connection between an end device of end user unit EUU1 and an end device of end user unit EUU2 as in Example 3 above. This second connection may be a connection providing higher quality communications than the communications over than the connection (FIG. 7b). The connection over A and B may then be, for example, terminated.

Where gateway G1 and/or G2 is used between connection means CM and an end user unit EUU1 and/or EUU2 (see FIG. 5a), the functioning of telecommunications web site 250 is as described in the examples above except that phone subsystem 205 is replaced or supplemented by a special IP switch. This IP switch acts as terminating device for TCP/IP connections to a gateway. The IP switch can also connect two TCP/IP connections from the switch to any gateway in order to enable gateway-to-gateway communication, and can therefore establish a connection between two different types of communication networks, such as PSTN, UMTS, etc. In other embodiments of the present invention, other types of gateway devices may be used, depending on the types of connections to be interfaced.

In the preceding specification, the present invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A web site for providing communications, comprising:
a processing device configured to provide, upon an accessing of a web page of the web site, private communications between an end user unit and a specific entity associated with the web page; and
an individual event settings element configured to define a rule for responding to an event.

2. The web site as recited in claim 1 wherein the rule defines a second event to be created when at least one criterion is satisfied.

3. The web site as recited in claim 2 wherein the at least one criterion includes the event and the at least one other event related by logical operators.

4. The web site as recited in claim 1 wherein the individual event settings element is configured to define the rule for responding to the event in combination with at least one other event.

5. The web site as recited in claim 1 wherein the individual event settings element includes a database.

6. The web site as recited in claim 1 further comprising an event identification element configured to identify a third event capable of changing a first state of the web site.

7. The web site as recited in claim 1 further comprising a caller recognition element configured to recognize a caller of the web site.

8. The web site as recited in claim 1 further comprising an event creation element configured to create a fourth event capable of changing a second state of the web site.

9. The web site as recited in claim 1 wherein the private communications are bi-directional between the end user unit and the specific entity.

10. The web site as recited in claim 1 wherein the accessing is an accessing by the first end user unit.

11. The web site as recited in claim 1 wherein the accessing is an accessing by the specific entity.

12. A communications environment, comprising:
a first end user unit configured for performing network-based communications; and
a web site corresponding to a specific entity and including an individual event settings element configured to define a rule for responding to an event, the web site being configured to provide, upon an accessing of the web site, private communications between the first end user unit and the specific entity.

13. The communications environment as recited in claim 12 wherein the rule defines a second event to be created when at least one criterion is satisfied.

14. The communications environment as recited in claim 13 wherein the at least one criterion includes the event and the at least one other event related by logical operators.

15. The communications environment as recited in claim 12 wherein the individual event settings element is configured to define the rule for responding to the event in combination with at least one other event.

16. The communications environment as recited in claim 12 wherein web site resides on a portal.

17. The communications environment as recited in claim 12 wherein the web site is configured to provide the private communications as function of the rule.

18. The communications environment as recited in claim 12 wherein the private communications are bi-directional between the end user unit and the specific entity.

19. A method for providing communications, comprising:
providing a web site configured to provide private communications between a calling party and a specific entity associated with a web page of the web site;
providing the web site with an individual event settings element;
defining, using the individual event settings element, a rule for responding to an event; and
responding to the event as a function of the rule.

20. The method as recited in claim 19 wherein the rule defines a second event to be created when at least one criterion is satisfied.

21. The method as recited in claim 20 wherein the at least one criterion includes the event and the at least one other event related by logical operators.

22. The method as recited in claim 19 wherein the individual event settings element is configured to define the rule for responding to the event in combination with at least one other event.

23. The method as recited in claim 19 wherein the private communications are bi-directional between the calling party and the specific entity.

24. The method as recited in claim 19 wherein the event is an incoming signal from the calling party and wherein the responding to the event includes creating a third event using an event creating element, and further comprising:
identifying the incoming signal using an event identification element;
receiving the incoming signal by a caller recognition element;
identifying the calling party using a database of the web site; and
receiving data on the identity of the calling party by the individual event settings element.

25. The method as recited in claim 24 wherein the creating the third event is performed based on the received data on the identity of the calling party.

26. A computer readable medium having stored thereon computer executable process steps operative to perform a method for providing communications, the method comprising:
providing a web site configured to provide private communications between a calling party and a specific entity associated with a web page of the web site;
providing the web site with an individual event settings element;
defining, using the individual event settings element, a rule for responding to an event; and
responding to the event as a function of the rule.

27. The computer readable medium as recited in claim 26 wherein the rule defines a second event to be created when at least one criterion is satisfied.

28. The computer readable medium as recited in claim 27 wherein the at least one criterion includes the event and the at least one other event related by logical operators.

29. The computer readable medium as recited in claim 26 wherein the individual event settings element is configured to define the rule for responding to the event in combination with at least one other event.

30. The computer readable medium as recited in claim 26 wherein the private communications are bidirectional between the calling party and the specific entity.

31. The computer readable medium as recited in claim 26 wherein the event is an incoming signal from the calling party and wherein the responding to the event includes creating a second event using an event creating element, and further comprising:
identifying the incoming signal using an event identification element;
receiving the incoming signal by a caller recognition element;
identifying the calling party using a database of the web site;
receiving data on the identity of the calling party by the individual event settings element.

32. The computer readable medium as recited in claim 26 wherein the creating the third event is performed based on the received data on the identity of the calling party.
